(19) United States
(12) Patent Application Publication
(10) Pub. No.: US 2023/0317110 A1
(43) Pub. Date: Oct. 5, 2023

(54) MAGNETIC RECORDING MEDIUM, MAGNETIC TAPE CARTRIDGE, AND MAGNETIC RECORDING AND REPRODUCING DEVICE

(71) Applicant: FUJIFILM Corporation, Tokyo (JP)

(72) Inventors: Noriko OYANAGI, Minamiashigara-shi (JP); Tatsuya YAMASHITA, Minamiashigara-shi (JP)

(73) Assignee: FUJIFILM Corporation, Tokyo (JP)

(21) Appl. No.: 18/191,311

(22) Filed: Mar. 28, 2023

(30) Foreign Application Priority Data
Mar. 31, 2022 (JP) 2022-059356

(51) Int. Cl. G11B 5/708; G11B 5/72

(52) U.S. Cl. CPC G11B 5/708; G11B 5/72

(57) ABSTRACT

Ra measured on a surface of a magnetic layer is 2.5 nm or less, and Δ(HD−HB) between a protrusion height HD with a height of a peripheral base region of 0 nm as a reference, which is measured by AFM, for a region specified as a dark region in a first binarization-processed image of a reflected electron image obtained by imaging the surface of the magnetic layer with SEM and a protrusion height HB with a height of a peripheral base region of 0 nm as a reference, which is measured by AFM, for a region specified as a bright region in a second binarization-processed image of the reflected electron image obtained by imaging the surface of the magnetic layer with SEM, the second binarization processing being performed on a higher gradation side than the first binarization processing, is 0.7 nm or more.

### CROSS-REFERENCE TO RELATED APPLICATIONS

This application claims priority under 35 U.S.C. 119 to Japanese Patent Application No. 2022-059356 filed on Mar. 31, 2022. The above application is hereby expressly incorporated by reference, in its entirety, into the present application.

### BACKGROUND OF THE INVENTION

1. Field of the Invention

The present invention relates to a magnetic recording medium, a magnetic tape cartridge, and a magnetic recording and reproducing device.

2. Description of the Related Art

A magnetic recording medium has been widely used as a recording medium for recording various pieces of data (see, for example, JP2014-209403A and JP2004-348897A).

### SUMMARY OF THE INVENTION

The magnetic recording medium is required to exhibit excellent electromagnetic conversion characteristics, and further improvement in electromagnetic conversion characteristics is desired.

The magnetic recording medium usually has a magnetic layer containing a ferromagnetic powder on a non-magnetic support, and a surface shape of the magnetic layer may affect a performance of the magnetic recording medium. Regarding the surface shape of the magnetic layer, JP2014-209403A and JP2004-348897A described above propose to control an existence state of protrusions on the magnetic layer surface. With respect to this, the present inventor aimed to provide a magnetic recording medium having more excellent electromagnetic conversion characteristics than those that can be achieved by the control of the existence state of the protrusions on the magnetic layer surface, which has been proposed in the related art, and specifically, a magnetic recording medium in which electromagnetic conversion characteristics less deteriorate after repeated running under a high temperature environment (for example, under a severe high temperature environment of an atmosphere temperature of 40° C. or higher, and even 60° C. or higher).

That is, an aspect of the present invention is to provide a magnetic recording medium in which electromagnetic conversion characteristics less deteriorate after repeated running under a high temperature environment.

An aspect of the present invention relates to a magnetic recording medium according to [1] below.

[1] A magnetic recording medium comprising: a non-magnetic support; and a magnetic layer containing a ferromagnetic powder, in which an arithmetic average roughness Ra measured on a surface of the magnetic layer (hereinafter, it is also described as a “magnetic layer surface Ra”) is 2.5 nm or less, and a protrusion height difference Δ (HD−HB) between a protrusion height HD with a height of a peripheral base region of 0 nm as a reference, which is measured by an atomic force microscope, for a region specified as a dark region in a first binarization-processed image of a reflected electron image obtained by imaging the surface of the magnetic layer with a scanning electron microscope and a protrusion height HB with a height of a peripheral base region of 0 nm as a reference, which is measured by the atomic force microscope, for a region specified as a bright region in a second binarization-processed image of the reflected electron image obtained by imaging the surface of the magnetic layer with the scanning electron microscope, the second binarization processing being performed on a higher gradation side than the first binarization processing, is 0.7 nm or more.

In one aspect, the magnetic recording medium according to [1] above can be the following magnetic recording medium.

[2] The magnetic recording medium according to [1], in which the protrusion height difference Δ is 0.7 nm or more and 3.0 nm or less.

[3] The magnetic recording medium according to [1] or [2], in which the arithmetic average roughness Ra is 0.8 nm or more and 2.5 nm or less.

[4] The magnetic recording medium according to any one of [1] to [3], in which the magnetic layer contains two or more kinds of non-magnetic powders.

[5] The magnetic recording medium according to [4], in which the non-magnetic powder of the magnetic layer includes an alumina powder.

[6] The magnetic recording medium according to [4] or [5], in which the non-magnetic powder of the magnetic layer includes carbon black.

[7] The magnetic recording medium according to any one of [1] to [6], further comprising: a non-magnetic layer containing a non-magnetic powder between the non-magnetic support and the magnetic layer.

[8] The magnetic recording medium according to any one of [1] to [7], further comprising: a back coating layer containing a non-magnetic powder on a surface side of the non-magnetic support opposite to a surface side on which the magnetic layer is provided.

[9] The magnetic recording medium according to any one of [1] to [8], in which the magnetic recording medium is a magnetic tape.

Another aspect of the present invention relates to a magnetic tape cartridge according to [10] below.

[10] A magnetic tape cartridge comprising: the magnetic tape according to [9].

Still another aspect of the present invention relates to a magnetic recording and reproducing device according to [11] below.

[11] A magnetic recording and reproducing device comprising: the magnetic recording medium according to any one of [1] to [9].

According to one aspect of the present invention, it is possible to provide a magnetic recording medium in which electromagnetic conversion characteristics less deteriorate after repeated running under a high temperature environment. In addition, according to one aspect of the present invention, it is possible to provide a magnetic tape cartridge and a magnetic recording and reproducing device including the magnetic recording medium.

### BRIEF DESCRIPTION OF THE DRAWINGS

FIG. 1 shows an arrangement example of a data band and a servo band.

FIG. 2 shows an arrangement example of a servo pattern of a linear tape-open (LTO) Ultrium format tape.

FIG. 3 is a schematic view of a reel tester used for running magnetic tapes of Examples and Comparative Examples.

### DESCRIPTION OF THE PREFERRED EMBODIMENTS

Magnetic Recording Medium

An aspect of the present invention relates to a magnetic recording medium including a non-magnetic support, and a magnetic layer containing a ferromagnetic powder. An arithmetic average roughness Ra measured on a surface of the magnetic layer is 2.5 nm or less. Further, a protrusion height difference Δ (HD−HB) between a protrusion height HD with a height of a peripheral base region of 0 nm as a reference, which is measured by an atomic force microscope, for a region specified as a dark region in a first binarization-processed image of a reflected electron image obtained by imaging the surface of the magnetic layer with a scanning electron microscope and a protrusion height HB with a height of a peripheral base region of 0 nm as a reference, which is measured by the atomic force microscope, for a region specified as a bright region in a second binarization-processed image of the reflected electron image obtained by imaging the surface of the magnetic layer with the scanning electron microscope, the second binarization processing being performed on a higher gradation side than the first binarization processing, is 0.7 nm or more. Regarding “HD” and “HB”, “H” is used as an abbreviation for height. Regarding “HD”, “D” is used as an abbreviation for a dark region. Regarding “HB”, “B” is used as an abbreviation for a bright region.

Usually, during running of the magnetic recording medium, the magnetic layer surface and a magnetic head come into contact with each other to be slid on each other. Wearing of the magnetic head by repeating such running (hereinafter, referred to as “head wear”) may result in deterioration of electromagnetic conversion characteristics after repeated running. The present inventor has conducted intensive studies, and as a result, it has been newly found that it is possible to provide a magnetic recording medium in which electromagnetic conversion characteristics less deteriorate after repeated running under a high temperature environment by making a region (specifically, a protrusion) specified as the dark region and a region (specifically, a protrusion) specified as the bright region exist on the surface of the magnetic layer having an arithmetic average roughness Ra of 2.5 nm or less and having excellent surface smoothness in a state where the protrusion height difference Δ is 0.7 nm or more. The present inventor considers that this is because such a magnetic recording medium can suppress head wear in repeated running under a high temperature environment.

Regarding a height of the protrusion, in JP2014-209403A, a height of the protrusion on the magnetic layer surface is measured by an atomic force microscope, and a plane in which a volume of convex components and a volume of concave components are equal to each other is defined as a reference plane, thereby obtaining a height of the protrusion by using a height of the reference plane of 0 nm (see paragraph 0016 of JP2014-209403A). In addition, in JP2004-348897A, a height of the protrusion on the magnetic layer surface is measured by an atomic force microscope, and a plane such that a volume of protrusions and a volume of recesses equal to each other is defined as a reference plane, thereby obtaining a height of the protrusion by using a height of the reference plane of 0 nm (see paragraph 0025 of JP2004-348897A). It is considered that the height of the protrusion is obtained in this way in consideration of the presence of waviness on the surface of the magnetic layer.

However, in reality, during running of the magnetic recording medium, usually, the magnetic recording medium runs in a magnetic recording and reproducing device while being applied with the tension, and therefore, it is speculated that the magnetic recording medium runs in a state where the waviness on the surface of the magnetic layer is elongated. In particular, since the magnetic layer is likely to soften under a high temperature environment, it is considered that the waviness on the surface of the magnetic layer may be more elongated. In this regard, the protrusion heights HD and HB are obtained using a height of a “peripheral base region”, which will be described in detail below, of 0 nm as a reference. The present inventor considers that the protrusion heights HD and HB thus obtained can be indicators of the protrusion state on the surface of the magnetic layer in a state where the waviness is elongated. Then, the present inventor found that it is possible to provide a magnetic recording medium in which electromagnetic conversion characteristics less deteriorate after repeated running under a high temperature environment by controlling the existence state of the protrusions on the surface of the magnetic layer with respect to such a protrusion height (that is, by controlling the protrusion height difference Δ).

Hereinafter, the protrusion height difference Δ and the magnetic layer surface Ra will be described in more detail. In the present invention and the present specification, the protrusion height difference Δ and the magnetic layer surface Ra of the magnetic recording medium are values measured using a new magnetic recording medium that has not been used after being shipped as a product.

Protrusion Height Difference Δ

The protrusion heights HD and HB in the present invention and the present specification are values obtained by the following method on the surface of the magnetic layer. In the present invention and the present specification, the “magnetic layer surface (surface of the magnetic layer)” has the same meaning as a surface of the magnetic recording medium on a magnetic layer side. The following measurement is performed using a sample piece cut out from a magnetic recording medium to be measured. A size of the sample piece may be any size as long as the following measurement is possible. A measurement environment is an environment in which an atmosphere temperature is 25° C.±2° C. and a relative humidity is 45%±25%.

(1) An atomic force microscope (AFM) image is acquired by imaging a region having an area of 10.0 μm×10.0 μm on the surface of the magnetic layer of the magnetic recording medium to be measured, in a tapping mode using an AFM. In the imaging, the sample piece is fixed such that a surface of the sample piece opposite to the magnetic layer surface is bonded to a sample table of the AFM with a fixing film in a state where the magnetic layer surface faces upward. As the fixing film, for example, a commercially available fixing film can be used. Examples of such a fixing film include FIXFILM series manufactured by Fujicopian Co., Ltd. In Examples and Comparative Examples described below, FIXFILM HGA2 manufactured by Fujicopian Co., Ltd. was used as the fixing film. One surface of the FIXFILM HGA2 is a pressure-sensitive adhesive surface and the other surface thereof is an adsorption surface. In Examples and Comparative Examples described below, the FIXFILM HGA2 was attached to the sample table of the AFM by the pressure-sensitive adhesive surface, and the adsorption surface of the FIXFILM HGA2 was bonded to the surface of the sample piece opposite to the magnetic layer surface. Imaging conditions are a scanning frequency of 0.70 Hz and a resolution of 512 pixels×512 pixels. By imaging in this way, AFM height data is acquired for the imaging region. As the AFM, S-image/Nanonavi manufactured by Hitachi High-Tech Science Corporation can be used in the measurement mode dynamic force microscope (DFM), and as a probe, SI-DF40 (Al coat on a back surface) manufactured by Hitachi High-Tech Science Corporation can be used. In measurement of Examples and Comparative Examples described below, the AFM and the probe were used, and a measurement mode was set to DFM.

(2) An SEM image is acquired using a scanning electron microscope (SEM) for the same region as the region in which the AFM image is acquired. As the scanning electron microscope, a field emission-scanning electron microscope (FE-SEM) is used. As the FE-SEM, for example, FE-SEM SU8220 manufactured by Hitachi High-Tech Corporation can be used, and, this FE-SEM was used in measurement for Examples and Comparative Examples described below. In addition, a coating treatment on the magnetic layer surface is not performed before an SEM image is captured. The acquired SEM image is a low angle-backscattered electron (LA-BSE) image. Hereinafter, it is simply referred to as a “reflected electron image”.

Imaging conditions are an acceleration voltage of 2 kV, an emission of 10 μA, a working distance of 4 mm, and an imaging magnification of 13,000×. Focus adjustment is performed under the above imaging conditions, and an SEM image (reflected electron image) is captured. A reflected electron image in which a part (for example, micron bar or cross mark) for displaying a size or the like is erased from the captured image is taken into image processing software, and registrated with the AFM image captured in the above (1), and then subjected to binarization processing. The registration is performed on a region having a central area of 8.5 μm×8.5 μm in the above-described imaging region having an area of 10.0 μm×10.0 μm. As image analysis software, for example, free software ImageJ can be used. ImageJ was used for Examples and Comparative Examples described below. The image is divided into a bright region (white part) and a dark region (black part) by binarization processing. As the binarization processing, the following two types of processing (first binarization processing and second binarization processing) are performed.

In the reflected electron image captured under the above imaging conditions, first binarization processing is performed as follows to create a first binarization-processed image.

A lower limit value is set to 0 gradations and an upper limit value is set to a value in a range of 75 gradations to 90 gradations, and the binarization processing is executed using these two threshold values (lower limit value and upper limit value). Before the binarization processing, noise component removal processing is performed by image analysis software. The noise component removal processing can be performed by the following method, for example. In Examples and Comparative Examples described below, the noise component removal processing was performed by the following method.

In image analysis software ImageJ, blur processing Gauss Filter is selected to remove a noise component.

The first binarization-processed image thus obtained is used as an image for specifying a dark region, and a part displayed as a dark region (that is, a black part) in this image is specified as a “dark region”. Areas of all the dark regions included in the first binarization-processed image are obtained by image analysis software. From the obtained area, an equivalent circle diameter of each dark region is obtained. Specifically, an equivalent circle diameter L is calculated from an obtained area A by (A/π)^(½)×2×L. Here, the operator “^” represents a power.

The equivalent circle diameter may be obtained in 1 nm increments by rounding off the first decimal point and rounding down the second decimal point.

In addition to the above-described binarization processing, second binarization processing is performed as follows to create a second binarization-processed image.

In the reflected electron image captured under the above imaging conditions, a lower limit value is set to a value in a range of 140 gradations to 170 gradations, an upper limit value is set to 255 gradations, and the binarization processing is executed using these two threshold values (lower limit value and upper limit value). Before the binarization processing, noise component removal processing is performed by image analysis software. The noise component removal processing can be performed by the following method, for example. In Examples and Comparative Examples described below, the noise component removal processing was performed by the following method.

In image analysis software ImageJ, blur processing Gauss Filter is selected to remove a noise component.

The second binarization-processed image thus obtained is used as an image for specifying a bright region, and a part displayed as a bright region (that is, a white part) in this image is specified as a “bright region”. Areas of all the bright regions included in the second binarization-processed image are obtained by image analysis software. From the obtained area, an equivalent circle diameter of each dark region is obtained. Specifically, an equivalent circle diameter L is calculated from an obtained area A by (A/π)^(½)×2=L.

(3) From the AFM height data of the region specified as the dark region by the registration described above, a height from the reference plane, that is, a height with the reference plane of 0 nm is obtained for each of all the regions specified as the dark region. Such a height is obtained as an arithmetic average of the AFM height data in each dark region. In the present invention and the present specification, the “reference plane” is defined as a plane in the imaging region in which a volume of convex components and a volume of concave components are equal to each other.

In this way, the height with the reference plane of 0 nm is obtained for all the regions specified as the dark region.

In addition, the “peripheral base region” is specified for all the regions specified as the dark region as follows.

For each dark region, a circle whose center is a position of the center of gravity of this region and diameter is an equivalent circle diameter of this region is set as a reference circle. A margin region and a peripheral base region are specified concentrically with the reference circle set in this way. Assuming that a radius of the reference circle is R (unit: nm), R=L/2, and the margin region is a donut-shaped region having a width of 50 nm, which is obtained by excluding a region surrounded by the reference circle from a region surrounded by a circle having a radius of (R+50) nm. The peripheral base region is a donut-shaped region having a width of 100 nm, which is obtained by excluding the region surrounded by a circle having a radius of (R+50) nm from a region surrounded by a circle having a radius of (R+50+100) nm. Note that since the shape of the region specified as the dark region is not limited to a circular shape, a part of the shape of the actual dark region may overlap the donut-shaped region specified as the peripheral base region. In such a case, the overlapping portion is to be excluded from the peripheral base region. From the AFM height data, a height of the peripheral base region thus specified, that is, a height with the reference plane of 0 nm is obtained. Such a height is obtained as an arithmetic average of the AFM height data in each peripheral base region.

In this way, the height with the reference plane of 0 nm is obtained for the peripheral base region of all the dark regions.

For all the dark regions (where, excluding a dark region in which the height of the peripheral base region is a negative value in a case where the reference plane is 0 nm), a value obtained by subtracting “the height of the peripheral base region with the reference plane of 0 nm” from “the height with the reference plane of 0 nm” is obtained. An arithmetic average of the values thus obtained is defined as “the protrusion height HD with the height of the peripheral base region of 0 nm as a reference”.

The above processing can be performed by image analysis software (for example, free software ImageJ), and ImageJ was used for Examples and Comparative Examples described below.

(4) In addition to the above (3), from the AFM height data of the region specified as the bright region by the registration described above, a height from the reference plane, that is, a height with the reference plane of 0 nm is obtained for each of all the regions specified as the bright region. Such a height is obtained as an arithmetic average of the AFM height data in each bright region.

In this way, the height with the reference plane of 0 nm is obtained for all the regions specified as the bright region.

In addition, for all the regions specified as the bright region, the “peripheral base region” is specified by the method described above for specifying the peripheral base region of the dark region. Specifically, the “peripheral base region” is specified as follows.

For each bright region, a circle whose center is a position of the center of gravity of this region and diameter is an equivalent circle diameter of this region is set as a reference circle. A margin region and a peripheral base region are specified concentrically with the reference circle set in this way. Assuming that a radius of the reference circle is R (unit: nm), R=L/2, and the margin region is a donut-shaped region having a width of 50 nm, which is obtained by excluding a region surrounded by the reference circle from a region surrounded by a circle having a radius of (R+50) nm. The peripheral base region is a donut-shaped region having a width of 100 nm, which is obtained by excluding the region surrounded by a circle having a radius of (R+50) nm from a region surrounded by a circle having a radius of (R+50+100) nm. Note that since the shape of the region specified as the bright region is not limited to a circular shape, a part of the shape of the actual bright region may overlap the donut-shaped region specified as the peripheral base region. In such a case, the overlapping portion is to be excluded from the peripheral base region. From the AFM height data, a height of the peripheral base region thus specified, that is, a height with the reference plane of 0 nm is obtained. Such a height is obtained as an arithmetic average of the AFM height data in each peripheral base region.

In this way, the height with the reference plane of 0 nm is obtained for the peripheral base region of all the bright regions.

For all the bright regions (where, excluding a bright region in which the height of the peripheral base region is a negative value in a case where the reference plane is 0 nm), a value obtained by subtracting “the height of the peripheral base region with the reference plane of 0 nm” from “the height with the reference plane of 0 nm” is obtained. An arithmetic average of the values thus obtained is defined as “the protrusion height HB with the height of the peripheral base region of 0 nm as a reference”.

The above processing can be performed by image analysis software (for example, free software ImageJ), and ImageJ was used for Examples and Comparative Examples described below.

The above (1) to (4) are performed for three different measurement regions randomly selected on the surface of the magnetic layer (n=3). An arithmetic average of the three HD values thus obtained is defined as “the protrusion height HD with the height of the peripheral base region of 0 nm as a reference” for the magnetic recording medium to be measured. An arithmetic average of the three HB values thus obtained is defined as “the protrusion height HB with the height of the peripheral base region of 0 nm as a reference” for the magnetic recording medium to be measured. Then, for the magnetic recording medium to be measured, a value (HD−HB) obtained by subtracting “the protrusion height HB with the height of the peripheral base region of 0 nm as a reference” from “the protrusion height HD with the height of the peripheral base region of 0 nm as a reference” is defined as the “protrusion height difference A”.

The present inventor speculates the protrusion height difference Δ as follows.

The magnetic layer of the magnetic recording medium usually includes a non-magnetic powder for imparting abradability to the magnetic layer surface (hereinafter, also referred to as an “abrasive”), and a non-magnetic powder for forming an appropriate protrusion on the magnetic layer surface (hereinafter, also referred to as a “filler”) in order to control friction characteristics. The present inventor considers that the region specified as the dark region by the above (2) is a protrusion formed on the magnetic layer surface by the filler, and that the region specified as the bright region by the above (2) is a protrusion formed on the magnetic layer surface by the abrasive. It is speculated that the head wear is mainly caused by the fact that the protrusion formed by the abrasive comes into contact with the head. Then, it is considered that making the protrusion formed by the filler protrude higher than the protrusion formed by the abrasive leads to suppression of the head wear generated due to such a cause. Further, for the magnetic recording medium, the protrusion height difference Δ is obtained by using the height of the peripheral base region as a reference (that is, with the height of the peripheral base region of 0 nm as a reference) instead of the reference plane. Setting the protrusion height difference Δ to 0.7 nm or more can contribute to suppression of deterioration in electromagnetic conversion characteristics after repeated running under a high temperature environment. Details of this point are as described above.

In the magnetic recording medium, the protrusion height difference Δ is 0.7 nm or more, preferably 0.8 nm or more, more preferably 0.9 nm or more, and still more preferably 1.0 nm or more from the viewpoint of suppressing deterioration in electromagnetic conversion characteristics after repeated running under a high temperature environment. The protrusion height difference Δ may be, for example, 3.0 nm or less. In one aspect, it is preferable that the protrusion height difference Δ is 3.0 nm or less from the viewpoint of improving the electromagnetic conversion characteristics at an initial stage of running.

For the control of the protrusion height difference Δ, for example, by using an abrasive having a small size and/or by using a filler having a large size, the value of the protrusion height difference Δ tends to be large. By enhancing a dispersion treatment of a dispersion liquid containing the filler (hereinafter, also referred to as a “filler liquid”) during preparation of a magnetic layer forming composition (for example, by increasing the number of times of the dispersion treatment), the value of the protrusion height difference Δ tends to be small. In addition, at any stage before being shipped as a product, the magnetic layer surface is made to slide on a sliding member while running the magnetic recording medium under tension, whereby particles of the non-magnetic powder (for example, the filler and/or the abrasive) protruding on the magnetic layer surface are scraped and/or pushed toward the inside of the magnetic layer. Thereby, one or both of HD and HB can be changed. As the sliding member, any sliding member can be used. For example, the magnetic head can also be used as the sliding member. For example, by adopting one or more of the above-described means, the protrusion height difference Δ can be controlled to be 0.7 nm or more.

Magnetic Layer Surface Ra

The arithmetic average roughness Ra (magnetic layer surface Ra) measured on the surface of the magnetic layer in the present invention and the present specification is obtained by the following method.

An atomic force microscope (AFM) is used for measuring the arithmetic average roughness Ra. The measurement region is a region of 40 μm square (40 μm×40 μm). The measurement is performed at three different measurement points randomly selected on the magnetic layer surface (n=3). An arithmetic average of three values obtained by such measurement is defined as a magnetic layer surface Ra of the magnetic recording medium to be measured. The following measurement conditions can be used as an example of the AFM measurement conditions. The following measurement conditions were adopted in Examples and Comparative Examples described below.

A region of an area of 40 μm×40 μm on the surface of the magnetic layer of the magnetic recording medium is measured with the AFM (Nanoscope 4 manufactured by Veeco Instruments, Inc.) in a tapping mode. RTESP-300 manufactured by BRUKER is used as a probe, a resolution is set to 512 pixels×512 pixels, and a scan speed is set to a speed at which one screen (512 pixels×512 pixels) is measured in 341 seconds.

The magnetic layer surface Ra of the magnetic recording medium is 2.5 nm or less, preferably 2.4 nm or less, and more preferably 2.3 nm or less. Setting the protrusion height difference Δ, which is required for the surface of the magnetic layer having the magnetic layer surface Ra of 2.5 nm or less and having excellent surface smoothness, to 0.7 nm or more can contribute to suppression of deterioration in electromagnetic conversion characteristics after repeated running under a high temperature environment. In addition, the magnetic layer surface Ra of the magnetic recording medium may be, for example, 0.8 nm or more, 0.9 nm or more, 1.0 nm or more, 1.1 nm or more, or 1.2 nm or more, or can be lower than the values exemplified above.

The magnetic layer surface Ra can be controlled by a well-known method such as adjustment of manufacturing conditions of the magnetic recording medium.

Hereinafter, the magnetic recording medium will be further described in detail.

Magnetic Layer

Ferromagnetic Powder

As a ferromagnetic powder contained in the magnetic layer, a well-known ferromagnetic powder as a ferromagnetic powder used in magnetic layers of various magnetic recording media can be used alone or in combination of two or more. From the viewpoint of improving recording density, it is preferable to use a ferromagnetic powder having a small average particle size. From this point, the average particle size of the ferromagnetic powder is preferably 50 nm or less, more preferably 45 nm or less, still more preferably 40 nm or less, still more preferably 35 nm or less, still more preferably 30 nm or less, still more preferably 25 nm or less, and still more preferably 20 nm or less. On the other hand, from the viewpoint of the magnetization stability, the average particle size of the ferromagnetic powder is preferably 5 nm or more, more preferably 8 nm or more, still more preferably 10 nm or more, still more preferably 15 nm or more, and still more preferably 20 nm or more.

Regarding the particle size of the ferromagnetic powder, an average particle volume may be used as an index of the particle size. From the viewpoint of improving recording density, the average particle volume is preferably 2500 nm³ or less, more preferably 2300 nm³ or less, still more preferably 2000 nm³ or less, and still more preferably 1500 nm³ or less. From the viewpoint of magnetization stability, the average particle volume of the ferromagnetic powder is preferably 500 nm³ or more, more preferably 600 nm³ or more, even more preferably 650 nm³ or more, and still preferably 700 nm³ or more. The average particle volume described above is a value obtained as a sphere-equivalent volume from the average particle size obtained by a method described below.

Hexagonal Ferrite Powder

Preferred specific examples of the ferromagnetic powder include a hexagonal ferrite powder. For details of the hexagonal ferrite powder, for example, descriptions disclosed in paragraphs 0012 to 0030 of JP2011-225417A, paragraphs 0134 to 0136 of JP2011-216149A, paragraphs 0013 to 0030 of JP2012-204726A, and paragraphs 0029 to 0084 of JP2015-127985A can be referred to.

In the present invention and the present specification, the term “hexagonal ferrite powder” refers to a ferromagnetic powder in which a hexagonal ferrite crystal structure is detected as a main phase by X-ray diffraction analysis. The main phase refers to a structure to which the highest intensity diffraction peak in an X-ray diffraction spectrum obtained by X-ray diffraction analysis is attributed. For example, in a case where the highest intensity diffraction peak is attributed to a hexagonal ferrite crystal structure in the X-ray diffraction spectrum obtained by X-ray diffraction analysis, it is determined that the hexagonal ferrite crystal structure is detected as the main phase. In a case where only a single structure is detected by X-ray diffraction analysis, this detected structure is set as the main phase. The hexagonal ferrite crystal structure includes at least an iron atom, a divalent metal atom, and an oxygen atom, as a constituent atom. The divalent metal atom is a metal atom that can be a divalent cation as an ion, and examples thereof may include an alkaline earth metal atom such as a strontium atom, a barium atom, and a calcium atom, and a lead atom. In the present invention and the present specification, a hexagonal strontium ferrite powder refers to a powder in which a main divalent metal atom is a strontium atom, and a hexagonal barium ferrite powder refers to a powder in which a main divalent metal atom is a barium atom. The main divalent metal atom refers to a divalent metal atom that accounts for the most on atom % basis in the divalent metal atom included in the powder. Note that a rare earth atom is not included in the above divalent metal atom. The “rare earth atom” in the present invention and the present specification is selected from the group consisting of a scandium atom (Sc), an yttrium atom (Y), and a lanthanoid atom. The lanthanoid atom is selected from the group consisting of a lanthanum atom (La), a cerium atom (Ce), a praseodymium atom (Pr), a neodymium atom (Nd), a promethium atom (Pm), a samarium atom (Sm), an europium atom (Eu), a gadolinium atom (Gd), a terbium atom (Tb), a dysprosium atom (Dy), a holmium atom (Ho), an erbium atom (Er), a thulium atom (Tm), an ytterbium atom (Yb), and a lutetium atom (Lu).

Hereinafter, the hexagonal strontium ferrite powder, which is an aspect of the hexagonal ferrite powder, will be described in more detail.

An activation volume of the hexagonal strontium ferrite powder is preferably in a range of 800 to 1600 nm³. The finely granulated hexagonal strontium ferrite powder having an activation volume in the above range is suitable for producing a magnetic recording medium exhibiting excellent electromagnetic conversion characteristics. The activation volume of the hexagonal strontium ferrite powder is preferably 800 nm³ or more, and may be, for example, 850 nm³ or more. Further, from the viewpoint of further improving the electromagnetic conversion characteristics, the activation volume of the hexagonal strontium ferrite powder is more preferably 1500 nm³ or less, still more preferably 1400 nm³ or less, still more preferably 1300 nm³ or less, still more preferably 1200 nm³ or less, and still more preferably 1100 nm³ or less. The same applies to an activation volume of the hexagonal barium ferrite powder.

The term “activation volume” refers to a unit of magnetization reversal and is an index indicating the magnetic size of a particle. An activation volume described in the present invention and the present specification and an anisotropy constant Ku which will be described below are values obtained from the following relational expression between a coercivity Hc and an activation volume V, by performing measurement in a coercivity Hc measurement portion at a magnetic field sweep rate of 3 minutes and 30 minutes using a vibrating sample magnetometer (measurement temperature: 23° C.±1° C.). For a unit of the anisotropy constant Ku, 1 erg/cc=1.0×10⁻¹ J/m³.

Hc=2Ku/Ms{1−[(kT/KuV)ln(At/0.693)]^{1/2}}

[In the expression, Ku: anisotropy constant (unit: J/m³), Ms: saturation magnetization (unit: kA/m), k: Boltzmann constant, T: absolute temperature (unit: K), V: activation volume (unit: cm³), A: spin precession frequency (unit: s⁻¹), and t: magnetic field reversal time (unit: s)]

The anisotropy constant Ku can be used as an index for reducing thermal fluctuation, in other words, for improving the thermal stability. The hexagonal strontium ferrite powder preferably has Ku of 1.8×10⁵ J/m³ or more, and more preferably has Ku of 2.0×10⁵ J/m³ or more. Ku of the hexagonal strontium ferrite powder may be, for example, 2.5×10⁵ J/m³ or less. Note that since higher Ku means higher thermal stability, which is preferable, a value thereof is not limited to the values exemplified above.

The hexagonal strontium ferrite powder may or may not include a rare earth atom. In a case where the hexagonal strontium ferrite powder includes a rare earth atom, it is preferable to include a rare earth atom at a content (bulk content) of 0.5 to 5.0 atom % with respect to 100 atom % of an iron atom. In one aspect, the hexagonal strontium ferrite powder including a rare earth atom may have a rare earth atom surface layer portion uneven distribution property. In the present invention and the present specification, the “rare earth atom surface layer portion uneven distribution property” means that a rare earth atom content with respect to 100 atom % of an iron atom in a solution obtained by partially dissolving the hexagonal strontium ferrite powder with an acid (hereinafter, referred to as a “rare earth atom surface layer portion content” or simply a “surface layer portion content” for a rare earth atom.) and a rare earth atom content with respect to 100 atom % of an iron atom in a solution obtained by totally dissolving the hexagonal strontium ferrite powder with an acid (hereinafter, referred to as a “rare earth atom bulk content” or simply a “bulk content” for a rare earth atom.) satisfy a ratio of a rare earth atom surface layer portion content/a rare earth atom bulk content >1.0. A rare earth atom content in the hexagonal strontium ferrite powder described below is synonymous with the rare earth atom bulk content. On the other hand, partial dissolution using an acid dissolves a surface layer portion of a particle constituting the hexagonal strontium ferrite powder, and thus, a rare earth atom content in a solution obtained by partial dissolution is a rare earth atom content in a surface layer portion of a particle constituting the hexagonal strontium ferrite powder. A rare earth atom surface layer portion content satisfying a ratio of “rare earth atom surface layer portion content/rare earth atom bulk content >1.0” means that in a particle constituting the hexagonal strontium ferrite powder, rare earth atoms are unevenly distributed in a surface layer portion (that is, more than an inside). The surface layer portion in the present invention and the present specification means a partial region from a surface of a particle constituting the hexagonal strontium ferrite powder toward an inside.

In a case where the hexagonal strontium ferrite powder includes the rare earth atom, a rare earth atom content (bulk content) is preferably in a range of 0.5 to 5.0 atom % with respect to 100 atom % of an iron atom. It is considered that a bulk content in the above range of the included rare earth atom and uneven distribution of the rare earth atoms in a surface layer portion of a particle constituting the hexagonal strontium ferrite powder contribute to suppression of a decrease in reproduction output during repeated reproduction. It is speculated that this is because the hexagonal strontium ferrite powder includes a rare earth atom with a bulk content in the above range, and rare earth atoms are unevenly distributed in a surface layer portion of a particle constituting the hexagonal strontium ferrite powder, whereby it is possible to increase an anisotropy constant Ku. The higher a value of an anisotropy constant Ku is, the more a phenomenon called thermal fluctuation can be suppressed (in other words, thermal stability can be improved). By suppressing the occurrence of thermal fluctuation, it is possible to suppress a decrease in reproduction output during repeated reproduction. It is speculated that uneven distribution of rare earth atoms in a particulate surface layer portion of the hexagonal strontium ferrite powder contributes to stabilization of spins of iron (Fe) sites in a crystal lattice of a surface layer portion, and thus, an anisotropy constant Ku may be increased.

It is speculated that the use of the hexagonal strontium ferrite powder having the rare earth atom surface layer portion uneven distribution property as the ferromagnetic powder of the magnetic layer contributes to the prevention of scraping of the magnetic layer surface due to the sliding on the magnetic head. That is, it is speculated that the hexagonal strontium ferrite powder having the rare earth atom surface layer portion uneven distribution property can also contribute to the improvement of running durability of the magnetic recording medium. It is speculated that this may be because uneven distribution of rare earth atoms on a surface of a particle constituting the hexagonal strontium ferrite powder contributes to an improvement of interaction between the particle surface and an organic substance (for example, a binding agent and/or an additive) contained in the magnetic layer, and, as a result, a strength of the magnetic layer is improved.

From the viewpoint of further suppressing a decrease in reproduction output during repeated reproduction and/or the viewpoint of further improving running durability, the rare earth atom content (bulk content) is more preferably in a range of 0.5 to 4.5 atom %, still more preferably in a range of 1.0 to 4.5 atom %, and still more preferably in a range of 1.5 to 4.5 atom %.

The bulk content is a content obtained by totally dissolving hexagonal strontium ferrite powder. In the present invention and the present specification, unless otherwise noted, the content of an atom means a bulk content obtained by totally dissolving the hexagonal strontium ferrite powder. The hexagonal strontium ferrite powder including a rare earth atom may include only one kind of rare earth atom as the rare earth atom, or may include two or more kinds of rare earth atoms. The bulk content in a case of including two or more kinds of rare earth atoms is obtained for the total of two or more kinds of rare earth atoms. This also applies to other components in the present invention and the present specification. That is, unless otherwise noted, a certain component may be used alone or in combination of two or more. A content amount or a content in a case where two or more components are used refers to that for the total of two or more components.

In a case where the hexagonal strontium ferrite powder includes a rare earth atom, the included rare earth atom need only be any one or more of rare earth atoms. As a rare earth atom that is preferable from the viewpoint of further suppressing a decrease in reproduction output during repeated reproduction, there are a neodymium atom, a samarium atom, an yttrium atom, and a dysprosium atom, here, the neodymium atom, the samarium atom, and the yttrium atom are more preferable, and a neodymium atom is still more preferable.

In the hexagonal strontium ferrite powder having a rare earth atom surface layer portion uneven distribution property, the rare earth atoms need only be unevenly distributed in the surface layer portion of a particle constituting the hexagonal strontium ferrite powder, and the degree of uneven distribution is not limited. For example, for the hexagonal strontium ferrite powder having a rare earth atom surface layer portion uneven distribution property, a ratio of a surface layer portion content of a rare earth atom obtained by partial dissolution under dissolution conditions which will be described below to a bulk content of a rare earth atom obtained by total dissolution under dissolution conditions which will be described below, that is, “surface layer portion content/bulk content” exceeds 1.0 and may be 1.5 or more. The fact that “surface layer portion content/bulk content” is larger than 1.0 means that in a particle constituting the hexagonal strontium ferrite powder, rare earth atoms are unevenly distributed in the surface layer portion (that is, more than an inside). Further, a ratio of a surface layer portion content of a rare earth atom obtained by partial dissolution under dissolution conditions which will be described below to a bulk content of a rare earth atom obtained by total dissolution under the dissolution conditions which will be described below, that is, “surface layer portion content/bulk content” may be, for example, 10.0 or less, 9.0 or less, 8.0 or less, 7.0 or less, 6.0 or less, 5.0 or less, or 4.0 or less. Note that, in the hexagonal strontium ferrite powder having a rare earth atom surface layer portion uneven distribution property, the rare earth atoms need only be unevenly distributed in the surface layer portion of a particle constituting the hexagonal strontium ferrite powder, and the “surface layer portion content/bulk content” is not limited to the exemplified upper limit or lower limit.

The partial dissolution and the total dissolution of the hexagonal strontium ferrite powder will be described below. For the hexagonal strontium ferrite powder present as a powder, the partially and totally dissolved sample powder is collected from the same lot of powder. Meanwhile, for the hexagonal strontium ferrite powder contained in the magnetic layer of the magnetic recording medium, a part of the hexagonal strontium ferrite powder extracted from the magnetic layer is subjected to partial dissolution, and the other part is subjected to total dissolution. The hexagonal strontium ferrite powder can be extracted from the magnetic layer by a method disclosed in a paragraph 0032 of JP2015-91747A, for example.

The partial dissolution means that dissolution is performed such that, at the end of dissolution, the residue of the hexagonal strontium ferrite powder can be visually confirmed in the solution. For example, by partial dissolution, it is possible to dissolve a region of 10 to 20 mass % of the particle constituting the hexagonal strontium ferrite powder with the total particle being 100 mass %. On the other hand, the total dissolution means that dissolution is performed such that, at the end of dissolution, the residue of the hexagonal strontium ferrite powder cannot be visually confirmed in the solution.

The partial dissolution and measurement of the surface layer portion content are performed by the following method, for example. Note that the following dissolution conditions such as the amount of sample powder are exemplified, and dissolution conditions for partial dissolution and total dissolution can be adopted in any manner.

A container (for example, a beaker) containing 12 mg of the sample powder and 10 mL of 1 mol/L hydrochloric acid is held on a hot plate at a set temperature of 70° C. for 1 hour. The obtained solution is filtered by a membrane filter of 0.1 μm. Elemental analysis of the filtrated solution thus obtained is performed by an inductively coupled plasma (ICP) analyzer. In this way, the surface layer portion content of a rare earth atom with respect to 100 atom % of an iron atom can be obtained. In a case where a plurality of kinds of rare earth atoms are detected by elemental analysis, the total content of all rare earth atoms is defined as the surface layer portion content. This also applies to the measurement of the bulk content.

Meanwhile, the total dissolution and measurement of the bulk content are performed by the following method, for example.

A container (for example, a beaker) containing 12 mg of the sample powder and 10 mL of 4 mol/L hydrochloric acid is held on a hot plate at a set temperature of 80° C. for 3 hours. Thereafter, the same procedure as the partial dissolution and the measurement of the surface layer portion content is carried out, and the bulk content with respect to 100 atom % of an iron atom can be obtained.

From the viewpoint of increasing the reproduction output in a case of reproducing data recorded on the magnetic recording medium, it is desirable that mass magnetization σs of the ferromagnetic powder included in the magnetic recording medium is high. In this regard, the hexagonal strontium ferrite powder including a rare earth atom but not having the rare earth atom surface layer portion uneven distribution property tends to have a larger decrease in σs than that of the hexagonal strontium ferrite powder including no rare earth atom. With respect to this, it is considered that the hexagonal strontium ferrite powder having a rare earth atom surface layer portion uneven distribution property is preferable in suppressing such a large decrease in σs. In one aspect, σs of the hexagonal strontium ferrite powder may be 45 A·m²/kg or more, and may be 47 A·m²/kg or more. On the other hand, from the viewpoint of noise reduction, σs is preferably 80 A·m²/kg or less and more preferably 60 A·m²/kg or less. σs can be measured using a well-known measuring device, such as a vibrating sample magnetometer, capable of measuring magnetic properties. In the present invention and the present specification, unless otherwise noted, the mass magnetization σs is a value measured at a magnetic field intensity of 15 kOe. 1 [kOe]=10⁶/4π[A/m]

Regarding the content (bulk content) of a constituent atom of the hexagonal strontium ferrite powder, a strontium atom content may be, for example, in a range of 2.0 to 15.0 atom % with respect to 100 atom % of an iron atom. In one aspect, in the hexagonal strontium ferrite powder, the divalent metal atom included in this powder can be only a strontium atom. In another aspect, the hexagonal strontium ferrite powder may include one or more other divalent metal atoms in addition to the strontium atom. For example, a barium atom and/or a calcium atom can be included. In a case where the other divalent metal atoms other than the strontium atom are included, a content of the barium atom and a content of the calcium atom in the hexagonal strontium ferrite powder respectively can be, for example, in a range of 0.05 to 5.0 atom % with respect to 100 atom % of the iron atom.

As the hexagonal ferrite crystal structure, a magnetoplumbite type (also referred to as an “M type”), a W type, a Y type, and a Z type are known. The hexagonal strontium ferrite powder may have any crystal structure. The crystal structure can be confirmed by X-ray diffraction analysis. In the hexagonal strontium ferrite powder, a single crystal structure or two or more crystal structures may be detected by X-ray diffraction analysis. For example, according to one aspect, in the hexagonal strontium ferrite powder, only the M-type crystal structure may be detected by X-ray diffraction analysis. For example, M-type hexagonal ferrite is represented by a composition formula of AFe₁₂O₁₉. Here, A represents a divalent metal atom, and in a case where the hexagonal strontium ferrite powder is the M type, A is only a strontium atom (Sr), or in a case where, as A, a plurality of divalent metal atoms are included, as described above, a strontium atom (Sr) accounts for the most on atom % basis. The divalent metal atom content of the hexagonal strontium ferrite powder is usually determined by the type of crystal structure of the hexagonal ferrite and is not particularly limited. The same applies to the iron atom content and the oxygen atom content. The hexagonal strontium ferrite powder may include at least an iron atom, a strontium atom, and an oxygen atom, and may further include a rare earth atom. Furthermore, the hexagonal strontium ferrite powder may or may not include atoms other than these atoms. As an example, the hexagonal strontium ferrite powder may include an aluminum atom (Al). A content of an aluminum atom may be, for example, 0.5 to 10.0 atom % with respect to 100 atom % of an iron atom. From the viewpoint of further suppressing a decrease in reproduction output during repeated reproduction, the hexagonal strontium ferrite powder includes an iron atom, a strontium atom, an oxygen atom, and a rare earth atom, and the content of atoms other than these atoms is preferably 10.0 atom % or less, more preferably in a range of 0 to 5.0 atom %, and may be 0 atom % with respect to 100 atom % of an iron atom. That is, in one aspect, the hexagonal strontium ferrite powder may not include atoms other than an iron atom, a strontium atom, an oxygen atom, and a rare earth atom. The content expressed in atom % is obtained by converting a content of each atom (unit: mass %) obtained by totally dissolving the hexagonal strontium ferrite powder into a value expressed in atom % using an atomic weight of each atom. Further, in the present invention and the present specification, the term “not included” for a certain atom means that a content measured by an ICP analyzer after total dissolution is 0 mass %. A detection limit of the ICP analyzer is usually 0.01 parts per million (ppm) or less on a mass basis. The term “not included” is used as a meaning including that an atom is included in an amount less than the detection limit of the ICP analyzer. In one aspect, the hexagonal strontium ferrite powder may not include a bismuth atom (Bi).

Metal Powder

Preferred specific examples of the ferromagnetic powder include a ferromagnetic metal powder. For details of the ferromagnetic metal powder, descriptions disclosed in paragraphs 0137 to 0141 of JP2011-216149A and paragraphs 0009 to 0023 of JP2005-251351A can be referred to, for example.

ϵ-Iron Oxide Powder

Preferred specific examples of the ferromagnetic powder include an ϵ-iron oxide powder. In the present invention and the present specification, the term “ϵ-iron oxide powder” refers to a ferromagnetic powder in which an ϵ-iron oxide crystal structure is detected as a main phase by X-ray diffraction analysis. For example, in a case where the highest intensity diffraction peak is attributed to an ϵ-iron oxide crystal structure in an X-ray diffraction spectrum obtained by X-ray diffraction analysis, it is determined that the ϵ-iron oxide crystal structure is detected as the main phase. As a method of manufacturing an ϵ-iron oxide powder, a producing method from a goethite, a reverse micelle method, and the like are known. All of the manufacturing methods are well known. Regarding a method of manufacturing an ϵ-iron oxide powder in which a part of Fe is substituted with substitutional atoms such as Ga, Co, Ti, Al, or Rh, a description disclosed in J. Jpn. Soc. Powder Metallurgy Vol. 61 Supplement, No. S1, pp. S280 to 5284, J. Mater. Chem. C, 2013, 1, pp. 5200 to 5206 can be referred to, for example. Note that the manufacturing method of the ϵ-iron oxide powder capable of being used as the ferromagnetic powder in the magnetic layer of the magnetic recording medium is not limited to the methods described here.

An activation volume of the ϵ-iron oxide powder is preferably in a range of 300 to 1500 nm³. The finely granulated ϵ-iron oxide powder having an activation volume in the above range is suitable for producing a magnetic recording medium exhibiting excellent electromagnetic conversion characteristics. The activation volume of the ϵ-iron oxide powder is preferably 300 nm³ or more, and may be, for example, 500 nm³ or more. In addition, from the viewpoint of further improving the electromagnetic conversion characteristics, the activation volume of the ϵ-iron oxide powder is more preferably 1400 nm³ or less, still more preferably 1300 nm³ or less, still more preferably 1200 nm³ or less, and still more preferably 1100 nm³ or less.

The anisotropy constant Ku can be used as an index for reducing thermal fluctuation, in other words, for improving the thermal stability. The ϵ-iron oxide powder preferably has Ku of 3.0×10⁴ J/m³ or more, and more preferably has Ku of 8.0×10⁴ J/m³ or more. Ku of the ϵ-iron oxide powder may be, for example, 3.0×10⁵ J/m³ or less. Note that since higher Ku means higher thermal stability, which is preferable, a value thereof is not limited to the values exemplified above.

From the viewpoint of increasing the reproduction output in a case of reproducing data recorded on the magnetic recording medium, it is desirable that mass magnetization σs of the ferromagnetic powder included in the magnetic recording medium is high. In this regard, in one aspect, σs of the ϵ-iron oxide powder may be 8 A·m²/kg or more, and may be 12 A·m²/kg or more. On the other hand, from the viewpoint of noise reduction, σs of the ϵ-iron oxide powder is preferably 40 A·m²/kg or less and more preferably 35 A·m²/kg or less.

In the present invention and the present specification, unless otherwise noted, an average particle size of various powders such as ferromagnetic powders is a value measured by the following method using a transmission electron microscope. The powder is imaged at an imaging magnification of 100,000× with a transmission electron microscope, and the image is printed on photographic printing paper or displayed on a display so that the total magnification is 500,000×, to obtain an image of particles configuring the powder. A target particle is selected from the obtained image of particles, an outline of the particle is traced by a digitizer, and a size of the particle (primary particle) is measured. The primary particles are independent particles without aggregation.

The measurement described above is performed regarding 500 particles randomly extracted. An arithmetic average of the particle sizes of 500 particles thus obtained is an average particle size of the powder. As the transmission electron microscope, a transmission electron microscope H-9000 manufactured by Hitachi, Ltd. can be used, for example. In addition, the measurement of the particle size can be performed by well-known image analysis software, for example, image analysis software KS-400 manufactured by Carl Zeiss. An average particle size shown in Examples which will be described below is a value measured by using a transmission electron microscope H-9000 manufactured by Hitachi, Ltd. as the transmission electron microscope, and image analysis software KS-400 manufactured by Carl Zeiss as the image analysis software, unless otherwise noted. In the present invention and the present specification, the powder means aggregation of a plurality of particles. For example, ferromagnetic powder means aggregation of a plurality of ferromagnetic particles. Further, the aggregation of the plurality of particles not only includes an aspect in which particles constituting the aggregate directly come into contact with each other, but also includes an aspect in which a binding agent or an additive which will be described below is interposed between the particles. The term “particle” is used to describe a powder in some cases.

As a method of collecting sample powder from the magnetic recording medium in order to measure the particle size, a method disclosed in a paragraph 0015 of JP2011-048878A can be adopted, for example.

In the present invention and the present specification, unless otherwise noted, (1) in a case where the shape of the particle observed in the particle photograph described above is a needle shape, a fusiform shape, or a columnar shape (here, a height is greater than a maximum long diameter of a bottom surface), the size (particle size) of the particles configuring the powder is shown as a length of a long axis configuring the particle, that is, a long axis length, (2) in a case where the shape of the particle is a plate shape or a columnar shape (here, a thickness or a height is smaller than a maximum long diameter of a plate surface or a bottom surface), the particle size is shown as a maximum long diameter of the plate surface or the bottom surface, and (3) in a case where the shape of the particle is a sphere shape, a polyhedron shape, or an amorphous shape, and the long axis configuring the particles cannot be specified from the shape, the particle size is shown as an equivalent circle diameter. The equivalent circle diameter refers to a value obtained by a circle projection method.

In addition, a length of a short axis, that is, a short axis length of the particles is measured in the measurement described above, and an acicular ratio of the powder is obtained as a value of “average long axis length/average short axis length” from an arithmetic average (average long axis length) of the long axis lengths obtained regarding the 500 particles and an arithmetic average (average short axis length) of short axis lengths. Here, unless otherwise noted, in a case of (1), the short axis length as the definition of the particle size is a length of a short axis configuring the particle, in a case of (2), the short axis length is a thickness or a height, and in a case of (3), the long axis and the short axis are not distinguished, thus, the value of (average long axis length/average short axis length) is assumed as 1, for convenience.

In addition, unless otherwise noted, in a case where the shape of the particle is specified, for example, in a case of definition of the particle size (1), the average particle size is an average long axis length, and in a case of the definition (2), the average particle size is an average plate diameter. In a case of the definition (3), the average particle size is an average diameter (also referred to as an average particle diameter).

The content (filling percentage) of the ferromagnetic powder of the magnetic layer is preferably in a range of 50 to 90 mass % and more preferably in a range of 60 to 90 mass %, with respect to the total mass of the magnetic layer. A high filling percentage of the ferromagnetic powder in the magnetic layer is preferable from the viewpoint of improvement of the recording density.

Binding Agent

The magnetic recording medium can be a coating type magnetic recording medium, and can include a binding agent in the magnetic layer. The binding agent is one or more resins. As the binding agent, various resins usually used as a binding agent of a coating type magnetic recording medium can be used. For example, as the binding agent, a resin selected from a polyurethane resin, a polyester resin, a polyamide resin, a vinyl chloride resin, an acrylic resin obtained by copolymerizing styrene, acrylonitrile, or methyl methacrylate, a cellulose resin such as nitrocellulose, an epoxy resin, a phenoxy resin, and a polyvinylalkylal resin such as polyvinyl acetal or polyvinyl butyral can be used alone or a plurality of resins can be mixed with each other to be used. Among these, a polyurethane resin, an acrylic resin, a cellulose resin, and a vinyl chloride resin are preferable. These resins may be homopolymers or copolymers. These resins can be used as the binding agent even in a non-magnetic layer and/or a back coating layer which will be described below.

For the binding agent described above, descriptions disclosed in paragraphs 0028 to 0031 of JP2010-24113A can be referred to. An average molecular weight of the resin used as the binding agent can be, for example, 10,000 to 200,000 as a weight-average molecular weight. Unless otherwise noted, the weight-average molecular weight in the present invention and the present specification is a value obtained by performing polystyrene conversion of a value measured by gel permeation chromatography (GPC) under the following measurement conditions. The weight-average molecular weight of the binding agent shown in Examples described below is a value obtained by performing polystyrene conversion of a value measured under the following measurement conditions. The binding agent may be used in an amount of, for example, 1.0 to 30.0 parts by mass with respect to 100.0 parts by mass of the ferromagnetic powder.

GPC device: HLC-8120 (manufactured by Tosoh Corporation) Column: TSK gel Multipore HXL-M (manufactured by Tosoh Corporation, 7.8 mm inner diameter (ID)×30.0 cm)

Eluent: Tetrahydrofuran (THF)

Curing Agent

A curing agent can also be used together with the resin which can be used as the binding agent. As the curing agent, in one aspect, a thermosetting compound which is a compound in which curing reaction (crosslinking reaction) proceeds due to heating can be used, and in another aspect, a photocurable compound in which a curing reaction (crosslinking reaction) proceeds due to light irradiation can be used. At least a part of the curing agent can be contained in the magnetic layer in a state of being reacted (crosslinked) with other components such as the binding agent, by proceeding of the curing reaction in the magnetic layer forming step. The same applies to the layer formed using this composition in a case where the composition used to form the other layer includes a curing agent. The preferred curing agent is a thermosetting compound, polyisocyanate is suitable. For details of the polyisocyanate, descriptions disclosed in paragraphs 0124 and 0125 of JP2011-216149A can be referred to. The curing agent can be used in the magnetic layer forming composition in an amount of, for example, 0 to 80.0 parts by mass, and preferably 50.0 to 80.0 parts by mass from the viewpoint of improving a strength of the magnetic layer, with respect to 100.0 parts by mass of the binding agent.

Additive

The magnetic layer may include one or more kinds of additives, as necessary. As the additive, a commercially available product can be suitably selected or manufactured by a well-known method according to the desired properties, and any amount thereof can be used. Examples of the additive include the curing agent described above. In addition, examples of the additive which can be included in the magnetic layer include a non-magnetic powder, a lubricant, a dispersing agent, a dispersing assistant, a fungicide, an antistatic agent, and an antioxidant. For example, for the lubricant, descriptions disclosed in paragraphs 0030 to 0033, 0035, and 0036 of JP2016-126817A can be referred to. The non-magnetic layer described below may include a lubricant. For the lubricant which can be contained in the non-magnetic layer, descriptions disclosed in paragraphs 0030, 0031, and 0034 to 0036 of JP2016-126817A can be referred to. For the dispersing agent, descriptions disclosed in paragraphs 0061 and 0071 of JP2012-133837A can be referred to. The dispersing agent may be added to a non-magnetic layer forming composition. For the dispersing agent that can be added to the non-magnetic layer forming composition, a description disclosed in a paragraph 0061 of JP2012-133837A can be referred to.

Filler

Examples of the non-magnetic powder that can be contained in the magnetic layer include a non-magnetic powder (filler) for forming an appropriate protrusion on the magnetic layer surface in order to control friction characteristics. As the filler, for example, a non-magnetic powder having an average particle size of 20 to 200 nm can be used. An aspect of the filler includes carbon black. In addition, another aspect of the filler includes colloidal particles. The colloidal particles are preferably inorganic colloidal particles, more preferably inorganic oxide colloidal particles, and still more preferably silica colloidal particles (colloidal silica), from the viewpoint of availability. In the present invention and the present specification, the term “colloidal particles” refers to particles which are dispersed without precipitation to generate a colloidal dispersion, in a case where 1 g of the particles is added to 100 mL of at least one organic solvent of methyl ethyl ketone, cyclohexanone, toluene, or ethyl acetate, or a mixed solvent including two or more kinds of the solvent described above at an optional mixing ratio. A content of the filler in the magnetic layer is, for example, preferably 0.2 to 3.0 parts by mass, and more preferably 0.3 to 1.0 parts by mass per 100.0 parts by mass of the ferromagnetic powder.

Abrasive

Examples of the non-magnetic powder that can be contained in the magnetic layer include a non-magnetic powder (abrasive) for imparting abradability to the magnetic layer surface. As the abrasive, a non-magnetic powder having a Mohs hardness of more than 8 is preferable, and a non-magnetic powder having a Mohs hardness of 9 or more is more preferable. A maximum value of a Mohs hardness is 10. On the other hand, as the filler, a non-magnetic powder having a low Mohs hardness as compared with a non-magnetic powder used as an abrasive, for example, a non-magnetic powder having a Mohs hardness of 8 or less can be used. The abrasive can be a powder of an inorganic substance and can also be a powder of an organic substance. The abrasive can be, for example, an inorganic or organic oxide powder or a carbide powder. Examples of the carbide include boron carbide (for example, B₄C) and titanium carbide (for example, TiC). Diamond can also be used as the abrasive. In an aspect, the abrasive is preferably an inorganic oxide powder. Specifically, examples of the inorganic oxide include alumina such as α-alumina (for example, Al₂O₃), titanium oxide (for example, TiO₂), cerium oxide (for example, CeO₂), and zirconium oxide (for example, ZrO₂), among these, alumina is preferable. A Mohs hardness of alumina is about 9. For the alumina powder, a description disclosed in a paragraph 0021 of JP2013-229090A can be referred to. As the abrasive, for example, a non-magnetic powder having an average particle size of 0.05 to 0.2 μm can be used. A content of the abrasive in the magnetic layer is, for example, preferably 2.0 to 10.0 parts by mass, and more preferably 4.0 to 8.0 parts by mass per 100.0 parts by mass of the ferromagnetic powder. The magnetic layer containing the abrasive can also contain an additive for improving dispersibility of the abrasive. Examples of such an additive include a dispersing agent disclosed in paragraphs 0012 to 0022 of JP2013-131285A.

The magnetic layer described above can be provided on a surface of the non-magnetic support directly or indirectly through the non-magnetic layer.

Non-Magnetic Layer

Next, the non-magnetic layer will be described. The magnetic recording medium may include a magnetic layer directly on the non-magnetic support surface or may include a magnetic layer on the non-magnetic support surface through one or a plurality of two or more non-magnetic layers including a non-magnetic powder.

From the viewpoint of increasing smoothness of the magnetic layer surface, it is preferable to increase surface smoothness of the non-magnetic layer which is a surface on which the magnetic layer is to be formed. From this point, it is preferable to use a non-magnetic powder having a small average particle size as the non-magnetic powder included in the non-magnetic layer. An average particle size of the non-magnetic powder is preferably in a range of 500 nm or less, more preferably 200 nm or less, still more preferably 100 nm or less, and still more preferably 50 nm or less. In addition, from the viewpoint of ease of improving dispersibility of the non-magnetic powder, the average particle size of the non-magnetic powder is preferably 5 nm or more, more preferably 7 nm or more, and still more preferably 10 nm or more.

The non-magnetic powder used for the non-magnetic layer may be an inorganic powder or an organic powder. In addition, carbon black and the like can be used.

For carbon black which can be used in the non-magnetic layer, for example, descriptions disclosed in paragraphs 0040 and 0041 of JP2010-24113A can be referred to. Carbon black generally tends to have a large particle size distribution and tends to have poor dispersibility. Therefore, the non-magnetic layer including carbon black tends to have low surface smoothness. From this point, in one aspect, the non-magnetic layer adjacent to the magnetic layer is preferably a non-magnetic layer including a non-magnetic powder other than carbon black as the non-magnetic powder, or a non-magnetic layer including carbon black as one of a plurality of kinds of non-magnetic powders and having a low ratio of carbon black to the total amount of the non-magnetic powder. In addition, it is preferable that a plurality of non-magnetic layers are provided, and the non-magnetic layer positioned closest to the magnetic layer is set as a non-magnetic layer including a non-magnetic powder other than carbon black as the non-magnetic powder. For example, it is preferable that two non-magnetic layers are provided between the non-magnetic support and the magnetic layer, the non-magnetic layer on the non-magnetic support side (also referred to as a “lower non-magnetic layer”) is set as a non-magnetic layer including carbon black as the non-magnetic powder, and the non-magnetic layer on the magnetic layer side (also referred to as an “upper non-magnetic layer”) is set as a non-magnetic layer including the non-magnetic powder other than carbon black as the non-magnetic powder. In addition, in the non-magnetic layer forming composition including a plurality of kinds of non-magnetic powders, the dispersibility of the non-magnetic powder tends to easily deteriorate, compared to that in the non-magnetic layer forming composition including one kind of non-magnetic powder. From this point, it is preferable to provide a plurality of non-magnetic layers and to reduce the kinds of the non-magnetic powder included in each non-magnetic layer. In addition, in one aspect, it is preferable to use a dispersing agent, in order to increase the dispersibility of the non-magnetic powder in the non-magnetic layer forming composition including a plurality of kinds of non-magnetic powders. Such a dispersing agent will be described below.

Examples of the inorganic powder include powders of metal, metal oxide, metal carbonate, metal sulfate, metal nitride, metal carbide, and metal sulfide. These non-magnetic powders can be purchased as a commercially available product or can be manufactured by a well-known method. For details thereof, descriptions disclosed in paragraphs 0146 to 0150 of JP2011-216149A can be referred to.

As one aspect of the non-magnetic powder, a non-magnetic iron oxide powder can be used. It is preferable to use a powder having a small particle size as the non-magnetic iron oxide powder, from the viewpoint of increasing the surface smoothness of the non-magnetic layer on which the magnetic layer is to be formed. From this point, it is preferable to use a non-magnetic iron oxide powder having an average particle size in the range described above. As the non-magnetic iron oxide powder, in one aspect, an α-iron oxide powder is preferable. The α-iron oxide is an iron oxide having an a phase as a main phase.

The content (filling percentage) of the non-magnetic powder of the non-magnetic layer is preferably in a range of 50 to 90 mass % and more preferably in a range of 60 to 90 mass %, with respect to the total mass of the non-magnetic layer. In a case where a plurality of non-magnetic layers are provided, the content of the non-magnetic powder in at least one non-magnetic layer is preferably in the range described above, and the content of the non-magnetic powder in more non-magnetic layers is more preferably in the range described above.

The non-magnetic layer contains a non-magnetic powder and can also contain a binding agent together with the non-magnetic powder. In regards to other details of a binding agent or an additive of the non-magnetic layer, a well-known technology regarding the non-magnetic layer can be applied. In addition, in regards to the type and the content of the binding agent, and the type and the content of the additive, for example, a well-known technology regarding the magnetic layer can be applied.

As the additive that can be included in the non-magnetic layer, a dispersing agent that can contribute to an improvement of the dispersibility of the non-magnetic powder can be used. Examples of the dispersing agent include a fatty acid represented by RCOOH (R is an alkyl group or an alkenyl group) (for example, a caprylic acid, a capric acid, a lauric acid, a myristic acid, a palmitic acid, a stearic acid, a behenic acid, an oleic acid, an elaidic acid, a linoleic acid, a linolenic acid, and the like); alkali metal salt or alkaline earth metal salt of the fatty acid; ester of the fatty acid; a compound containing fluorine of ester of the fatty acid; amide of the fatty acid; polyalkylene oxide alkyl phosphates ester; lecithin; trialkyl polyolefin oxyquaternary ammonium salt (alkyl group contained is an alkyl group having 1 to 5 carbon atoms, olefin contained is ethylene, propylene, or the like); phenylphosphonic acid; and copper phthalocyanine. These may be used alone or in combination of two or more kinds thereof. The content of the dispersing agent is preferably 0.2 to 5.0 parts by mass with respect to 100.0 parts by mass of the non-magnetic powder.

In addition, as an example of an additive, organic tertiary amine can be used. For the organic tertiary amine, descriptions disclosed in paragraphs 0011 to 0018 and 0021 of JP2013-049832A can be referred to. The organic tertiary amine can contribute to an improvement of dispersibility of carbon black. For the formulation of a composition for increasing the dispersibility of carbon black with the organic tertiary amine, paragraphs 0022 to 0024 and 0027 of JP2013-049832A can be referred to.

The amine is more preferably trialkylamine. The alkyl group contained in the trialkylamine is preferably an alkyl group having 1 to 18 carbon atoms. Three alkyl groups contained in the trialkylamine may be the same as or different from each other. For details of the alkyl group, descriptions disclosed in paragraphs 0015 and 0016 of JP2013-049832A can be referred to. As the trialkylamine, trioctylamine is particularly preferable.

The non-magnetic layer of the present invention and the present specification also includes a substantially non-magnetic layer containing a small amount of ferromagnetic powder as impurities or intentionally, together with the non-magnetic powder. Here, the substantially non-magnetic layer is a layer having a residual magnetic flux density equal to or smaller than 10 mT, a layer having a coercivity equal to or smaller than 7.96 kA/m (100 Oe), or a layer having a residual magnetic flux density equal to or smaller than 10 mT and a coercivity equal to or smaller than 7.96 kA/m (100 Oe). It is preferable that the non-magnetic layer does not have a residual magnetic flux density and a coercivity.

Non-Magnetic Support

Next, the non-magnetic support will be described. Examples of the non-magnetic support (hereinafter, simply referred to as a “support”) include well-known components such as polyethylene terephthalate, polyethylene naphthalate, polyamide, polyamideimide, and aromatic polyamide subjected to biaxial stretching. Among these, polyethylene terephthalate, polyethylene naphthalate, and polyamide are preferable. A corona discharge, a plasma treatment, an easy-bonding treatment, or a heat treatment may be performed on these supports in advance.

Back Coating Layer

The magnetic recording medium may or may not include a back coating layer including a non-magnetic powder on a surface side of the non-magnetic support opposite to a surface side on which the magnetic layer is provided. The back coating layer preferably contains any one or both of carbon black and an inorganic powder. The back coating layer can include a binding agent and can also include additives. In regards to the binding agent and the additive of the back coating layer, a well-known technology regarding the back coating layer can be applied, and a well-known technology regarding the formulation of components of the magnetic layer and/or the non-magnetic layer can be applied. For example, for the back coating layer, descriptions disclosed in paragraphs 0018 to 0020 of JP2006-331625A and column 4, line 65 to column 5, line 38 of U.S. Pat. No. 7,029,774B can be referred to.

Various Thicknesses

Regarding a thickness (total thickness) of the magnetic recording medium, it has been required to increase the recording capacity (increase the capacity) of the magnetic recording medium with the enormous increase in the amount of information in recent years. As means for increasing the capacity, reducing a thickness of the magnetic recording medium (hereinafter, also referred to as “thinning”), for example, increasing a length of the magnetic tape accommodated in one roll of a magnetic tape cartridge is used. For example, from this point, the thickness (total thickness) of the magnetic recording medium is preferably 5.6 μm or less, more preferably 5.5 μm or less, still more preferably 5.4 μm or less, still more preferably 5.3 μm or less, and still more preferably 5.2 μm or less. In addition, from the viewpoint of ease of handling, the thickness of the magnetic recording medium is preferably 3.0 μm or more, and more preferably 3.5 μm or more.

For example, the thickness (total thickness) of the magnetic recording medium can be measured by the following method.

Ten samples (for example, 5 to 10 cm in length) are cut out from any part of the magnetic recording medium, and these samples are stacked to measure the thickness. A value (thickness per sample) obtained by dividing the measured thickness by 1/10 is defined as the magnetic recording medium thickness. The thickness measurement can be performed using a well-known measuring instrument capable of measuring a thickness on the order of 0.1 μm.

A thickness of the non-magnetic support is preferably 3.0 to 5.0 μm.

A thickness of the magnetic layer can be optimized according to a saturation magnetization amount of a magnetic head used, a head gap length, a recording signal band, and the like, is generally 0.01 μm to 0.15 μm, and is preferably 0.02 μm to 0.12 μm and more preferably 0.03 μm to 0.1 μm, from a viewpoint of realization of high-density recording. The magnetic layer may be at least one layer, or the magnetic layer can be separated into two or more layers having different magnetic properties, and a configuration regarding a well-known multilayered magnetic layer can be applied. A thickness of the magnetic layer in a case where the magnetic layer is separated into two or more layers is a total thickness of the layers. This point also applies to the thickness of the non-magnetic layer in the magnetic recording medium including a plurality of non-magnetic layers.

Regarding the thickness of the non-magnetic layer, as a thicker non-magnetic layer is formed, a presence state of the particles of the non-magnetic powder easily becomes non-uniform in a coating step and a drying step of the non-magnetic layer forming composition, and the difference in thickness at each position tends to increase thereby roughening the surface of the non-magnetic layer. From the viewpoint of increasing the smoothness of the magnetic layer surface, it is preferable that the surface smoothness of the non-magnetic layer is high. From this point, the thickness of the non-magnetic layer is preferably 1.5 μm or less and more preferably 1.0 μm or less. In addition, the thickness of the non-magnetic layer is preferably 0.05 μm or more and more preferably 0.1 μm or more, from the viewpoint of improving the uniformity of coating of the non-magnetic layer forming composition.

A thickness of the back coating layer is preferably equal to or smaller than 0.9 μm and more preferably 0.1 to 0.7 μm.

Various thicknesses such as the thickness of the magnetic layer can be obtained by the following method.

A cross section of the magnetic recording medium in a thickness direction is exposed by an ion beam, and then the exposed cross section observation is performed using a scanning electron microscope. Various thicknesses can be obtained as an arithmetic average of thicknesses obtained at two optional points in the cross section observation. Alternatively, the various thicknesses can be obtained as a designed thickness calculated according to manufacturing conditions.

Manufacturing Step

Preparation of Each Layer Forming Composition

A step of preparing a composition for forming the magnetic layer, the non-magnetic layer, or the back coating layer can usually include at least a kneading step, a dispersing step, and, as necessary, a mixing step provided before and after these steps. Each step may be divided into two or more stages. Components used for the preparation of each layer forming composition may be added at an initial stage or in a middle stage of each step. As a solvent, one or more kinds of various solvents usually used for manufacturing a coating type magnetic recording medium can be used. For the solvent, for example, a description disclosed in a paragraph 0153 of JP2011-216149A can be referred to. In addition, each component may be separately added in two or more steps. For example, a binding agent may be added separately in a kneading step, a dispersing step, and a mixing step for adjusting a viscosity after dispersion. In order to manufacture the above magnetic recording medium, a well-known manufacturing technology can be used in various steps. In the kneading step, an open kneader, a continuous kneader, a pressure kneader, or a kneader having a strong kneading force such as an extruder is preferably used. For details of the kneading treatment, descriptions disclosed in JP1989-106338A (JP-H01-106338A) and JP1989-79274A (JP-H01-79274A) can be referred to. As a disperser, a well-known disperser can be used. In one aspect, a dispersion liquid of the abrasive (hereinafter, also referred to as an “abrasive solution”) can be prepared by being separately dispersed from the ferromagnetic powder and the filler. In addition, in one aspect, a dispersion liquid of the filler (filler liquid) can be prepared by being separately dispersed from the ferromagnetic powder and the abrasive. In any stage of preparing each layer forming composition, filtering may be performed by a well-known method. The filtering can be performed by using a filter, for example. As the filter used in the filtering, a filter having a pore diameter of 0.01 to 3 μm (for example, filter made of glass fiber or filter made of polypropylene) can be used, for example.

Coating Step

The magnetic layer can be formed by directly applying the magnetic layer forming composition onto the non-magnetic support surface or performing multilayer coating of the magnetic layer forming composition with the non-magnetic layer forming composition in order or at the same time. From the viewpoint of improving the smoothness of the magnetic layer surface, it is preferable to perform successive multilayer coating. The back coating layer can be formed by applying a back coating layer forming composition onto a surface of the non-magnetic support opposite to a surface having the non-magnetic layer and/or the magnetic layer (or to be provided with the non-magnetic layer and/or the magnetic layer). For details of the coating for forming each layer, a description disclosed in a paragraph 0066 of JP2010-231843A can be referred to.

Other Steps

After the coating step, various treatments such as a drying treatment, an alignment treatment of the magnetic layer, and a surface smoothing treatment (calendering treatment) can be performed. For various steps, for example, a well-known technology disclosed in paragraphs 0052 to 0057 of JP2010-24113A can be referred to. For example, the coating layer of the magnetic layer forming composition can be subjected to an alignment treatment, while the coating layer is in an undried state. For the alignment treatment, various well-known technologies including a description disclosed in a paragraph 0067 of JP2010-231843A can be used. For example, a vertical alignment treatment can be performed by a well-known method such as a method using a polar opposing magnet. In an alignment zone, a drying speed of the coating layer can be controlled depending on a temperature, an air volume of drying air and/or a transportation speed of the non-magnetic support on which the coating layer is formed in the alignment zone. In addition, the coating layer may be preliminarily dried before the transportation to the alignment zone. For the calendering treatment, in a case where a calendering condition is strengthened, the smoothness of the magnetic layer surface tends to increase. Examples of the calendering condition include the number of times the calendering treatment is performed (hereinafter, also referred to as “the number of times of calendering”), a calender pressure, a calender temperature (surface temperature of a calender roll), a calender speed, and a hardness of a calender roll. As the number of times of calendering increases, the calendering treatment is enhanced. As for the calender pressure, the calender temperature, and the hardness of the calender roll, the calendering treatment is enhanced by increasing these values, and the calendering treatment is enhanced by decreasing the calender speed. For example, the calender pressure (linear pressure) may be 200 to 500 kg/cm and is preferably 250 to 350 kg/cm. The calender temperature (surface temperature of the calender roll) may be, for example, 85° C. to 120° C. and is preferably 90° C. to 110° C., and the calender speed may be, for example, 50 to 300 m/min and is preferably 50 to 200 m/min.

Through various steps, a long magnetic tape original roll can be obtained. The obtained magnetic tape original roll is cut (slit) by a well-known cutter, for example, to have a width of the magnetic tape to be wound around the magnetic tape cartridge. The width is determined according to the standard and is usually ½ inches. ½ inches=12.65 mm.

A servo pattern is usually formed on the magnetic tape obtained by slitting. Details of the servo pattern will be described below.

Heat Treatment

In one aspect, the magnetic recording medium can be a magnetic tape manufactured through the following heat treatment. In another aspect, the magnetic recording medium can be a magnetic tape manufactured without the following heat treatment.

As the heat treatment, the magnetic tape slit and cut to have a width determined according to the standard described above can be wound around a core member and can be subjected to the heat treatment in the wound state.

In one aspect, the heat treatment is performed in a state where the magnetic tape is wound around a core member for the heat treatment (hereinafter, referred to as a “winding core for heat treatment”), the magnetic tape after the heat treatment is wound around a reel of the magnetic tape cartridge, and the magnetic tape cartridge in which the magnetic tape is wound around the reel can be produced.

The winding core for heat treatment can be formed of metal, a resin, or paper. The material of the winding core for heat treatment is preferably a material having high stiffness, from the viewpoint of suppressing the occurrence of winding failure such as spoking. From this point, the winding core for heat treatment is preferably formed of metal or a resin. In addition, as an index for stiffness, a bending elastic modulus of the material of the winding core for heat treatment is preferably 0.2 GPa (Gigapascal) or more, and more preferably 0.3 GPa or more. Meanwhile, since the material having high stiffness is generally expensive, the use of the winding core for heat treatment of the material having stiffness exceeding the stiffness capable of suppressing the occurrence of the winding failure leads to an increase in cost. Considering the above point, the bending elastic modulus of the material of the winding core for heat treatment is preferably 250 GPa or less. The bending elastic modulus is a value measured in accordance with international organization for standardization (ISO) 178, and the bending elastic modulus of various materials is well-known. In addition, the winding core for heat treatment can be a solid or hollow core member. In a case of the hollow core member, a thickness thereof is preferably 2 mm or more from the viewpoint of maintaining stiffness. In addition, the winding core for heat treatment may include or may not include a flange.

It is preferable to prepare a magnetic tape having a length equal to or more than a length to be finally accommodated in the magnetic tape cartridge (hereinafter, referred to as a “final product length”) as the magnetic tape wound around the winding core for heat treatment, and to perform the heat treatment by placing the magnetic tape in a heat treatment environment while being wound around the winding core for heat treatment. The length of the magnetic tape wound around the winding core for heat treatment is equal to or more than the final product length, and is preferably the “final product length+α”, from the viewpoint of ease of winding around the winding core for heat treatment. This α is preferably 5 m or more, from the viewpoint of ease of the winding. The tension during winding around the winding core for heat treatment is preferably 0.1 N (Newton) or more. In addition, from the viewpoint of suppressing the occurrence of excessive deformation, the tension during winding around the winding core for heat treatment is preferably 1.5 N or less, and more preferably 1.0 N or less. An outer diameter of the winding core for heat treatment is preferably 20 mm or more and more preferably 40 mm or more, from the viewpoint of ease of the winding and suppression of coiling (curling in longitudinal direction). In addition, the outer diameter of the winding core for heat treatment is preferably 100 mm or less, and more preferably 90 mm or less. A width of the winding core for heat treatment need only be equal to or more than the width of the magnetic tape wound around this winding core. In addition, in a case where the magnetic tape is removed from the winding core for heat treatment after the heat treatment, it is preferable to remove the magnetic tape from the winding core for heat treatment after the magnetic tape and the winding core for heat treatment are sufficiently cooled, in order to suppress occurrence of unintended deformation of the tape during the removal operation. It is preferable that the removed magnetic tape is once wound around another winding core (referred to as a “temporary winding core”), and then the magnetic tape is wound around the reel (generally, an outer diameter is about 40 to 50 mm.) of the magnetic tape cartridge from the temporary winding core. As a result, the magnetic tape can be wound around the reel of the magnetic tape cartridge while maintaining a relationship between the inner side and the outer side with respect to the winding core for heat treatment of the magnetic tape during the heat treatment. Regarding the details of the temporary winding core and the tension in a case of winding the magnetic tape around the winding core, the description described above regarding the winding core for heat treatment can be referred to. In an aspect in which the heat treatment is applied to the magnetic tape having a length of the “final product length+α”, the length corresponding to “+α” need only be cut off in any stage. For example, in one aspect, the magnetic tape for the final product length need only be wound around the reel of the magnetic tape cartridge from the temporary winding core, and the remaining length corresponding to “+α” need only be cut off. From the viewpoint of reducing a portion to be cut off and discarded, the α is preferably 20 m or less.

A specific aspect of the heat treatment performed in a state where the magnetic tape is wound around the core member as described above will be described below.

An atmosphere temperature at which the heat treatment is performed (hereinafter, referred to as a “heat treatment temperature”) is preferably 40° C. or higher, and more preferably 50° C. or higher. On the other hand, from the viewpoint of suppressing excessive deformation, the heat treatment temperature is preferably 75° C. or lower, more preferably 70° C. or lower, and still more preferably 65° C. or lower.

A weight-basis absolute humidity of an atmosphere in which the heat treatment is performed is preferably 0.1 g/kg Dry air or more, and more preferably 1 g/kg Dry air or more. An atmosphere having a weight-basis absolute humidity in the above range is preferable because it can be prepared without using a special device for reducing moisture. On the other hand, the weight-basis absolute humidity is preferably 70 g/kg Dry air or less, and more preferably 66 g/kg Dry air or less, from the viewpoint of suppressing occurrence of dew condensation and deterioration of workability. A heat treatment time is preferably 0.3 hours or longer, and more preferably 0.5 hours or longer. In addition, the heat treatment time is preferably 48 hours or less, from the viewpoint of production efficiency.

Formation of Servo Pattern

The magnetic recording medium can be a tape-shaped magnetic recording medium (that is, magnetic tape), and can also be a disk-shaped magnetic recording medium (that is, magnetic disk). In any aspect, the magnetic layer can have a servo pattern. The term “formation of servo pattern” can also be referred to as “recording of servo signal”. Hereinafter, the formation of the servo patterns will be described using a magnetic tape as an example.

The servo pattern is usually formed along the longitudinal direction of the magnetic tape. Examples of control (servo control) systems using a servo signal include a timing-based servo (TBS), an amplitude servo, and a frequency servo.

As shown in European Computer Manufacturers Association (ECMA)-319 (June 2001), a timing-based servo system is adopted in a magnetic tape based on a linear tape-open (LTO) standard (generally referred to as an “LTO tape”). In this timing-based servo system, the servo pattern is formed by continuously disposing a plurality of pairs of non-parallel magnetic stripes (also referred to as “servo stripes”) in the longitudinal direction of the magnetic tape. In the present invention and the present specification, the term “timing-based servo pattern” refers to a servo pattern that enables head tracking in a timing-based servo system. As described above, the reason why the servo pattern is formed of a pair of non-parallel magnetic stripes is to indicate, to a servo signal reading element passing over the servo pattern, a passing position thereof. Specifically, the pair of magnetic stripes is formed such that an interval thereof continuously changes along a width direction of the magnetic tape, and the servo signal reading element reads the interval to thereby sense a relative position between the servo pattern and the servo signal reading element. Information on this relative position enables tracking on a data track. Accordingly, a plurality of servo tracks are usually set on the servo pattern along the width direction of the magnetic tape.

A servo band is formed of a servo pattern continuous in the longitudinal direction of the magnetic tape. A plurality of the servo bands are usually provided on the magnetic tape. For example, in an LTO tape, the number of the servo bands is five. Regions interposed between two adjacent servo bands are data bands. The data band is formed of a plurality of data tracks and each data track corresponds to each servo track.

Further, in one aspect, as shown in JP2004-318983A, information indicating a servo band number (referred to as “servo band identification (ID)” or “unique data band identification method (UDIM) information”) is embedded in each servo band. This servo band ID is recorded by shifting a specific one of the plurality of pairs of the servo stripes in the servo band so that positions thereof are relatively displaced in the longitudinal direction of the magnetic tape. Specifically, a way of shifting the specific one of the plurality of pairs of servo stripes is changed for each servo band. Accordingly, the recorded servo band ID is unique for each servo band, and thus, the servo band can be uniquely specified only by reading one servo band with a servo signal reading element.

As a method for uniquely specifying the servo band, there is a method using a staggered method as shown in ECMA-319 (June 2001). In this staggered method, a group of pairs of non-parallel magnetic stripes (servo stripes) disposed continuously in plural in a longitudinal direction of the magnetic tape is recorded so as to be shifted in a longitudinal direction of the magnetic tape for each servo band. Since this combination of shifting methods between adjacent servo bands is unique throughout the magnetic tape, it is possible to uniquely specify a servo band in a case of reading a servo pattern with two servo signal reading elements.

As shown in ECMA-319 (June 2001), information indicating a position of the magnetic tape in the longitudinal direction (also referred to as “longitudinal position (LPOS) information”) is usually embedded in each servo band. This LPOS information is also recorded by shifting the positions of the pair of servo stripes in the longitudinal direction of the magnetic tape, as the UDIM information. Note that, unlike the UDIM information, in this LPOS information, the same signal is recorded in each servo band.

It is also possible to embed, in the servo band, the other information different from the above UDIM information and LPOS information. In this case, the embedded information may be different for each servo band as the UDIM information or may be common to all servo bands as the LPOS information.

As a method of embedding the information in the servo band, a method other than the method described above can be adopted. For example, a predetermined code may be recorded by thinning out a predetermined pair from the group of pairs of servo stripes.

A head for forming a servo pattern is called a servo write head. The servo write head usually has a pair of gaps corresponding to the pair of magnetic stripes as many as the number of servo bands. Usually, a core and a coil are connected to each pair of gaps, and by supplying a current pulse to the coil, a magnetic field generated in the core can cause generation of a leakage magnetic field in the pair of gaps. In a case of forming the servo pattern, by inputting a current pulse while running the magnetic tape on the servo write head, the magnetic pattern corresponding to the pair of gaps is transferred to the magnetic tape to form the servo pattern. A width of each gap can be appropriately set according to a density of the servo pattern to be formed. The width of each gap can be set to, for example, 1 μm or less, 1 to 10 μm, 10 μm or more, and the like.

Before the servo pattern is formed on the magnetic tape, the magnetic tape is usually subjected to a demagnetization (erasing) treatment. This erasing treatment can be performed by applying a uniform magnetic field to the magnetic tape using a direct current magnet or an alternating current magnet. The erasing treatment includes direct current (DC) erasing and alternating current (AC) erasing. The AC erasing is performed by gradually decreasing an intensity of the magnetic field while reversing a direction of the magnetic field applied to the magnetic tape. Meanwhile, the DC erasing is performed by applying a unidirectional magnetic field to the magnetic tape. The DC erasing further includes two methods. A first method is horizontal DC erasing of applying a unidirectional magnetic field along a longitudinal direction of the magnetic tape. A second method is vertical DC erasing of applying a unidirectional magnetic field along a thickness direction of the magnetic tape. The erasing treatment may be performed on the entire magnetic tape or may be performed for each servo band of the magnetic tape.

A direction of the magnetic field of the servo pattern to be formed is determined according to a direction of the erasing. For example, in a case where the horizontal DC erasing is performed to the magnetic tape, the servo pattern is formed so that the direction of the magnetic field is opposite to the direction of the erasing. Therefore, an output of a servo signal obtained by reading the servo pattern can be increased. As shown in JP2012-53940A, in a case where the magnetic pattern is transferred to, using the gap, a magnetic tape that has been subjected to the vertical DC erasing, a servo signal obtained by reading the formed servo pattern has a monopolar pulse shape. Meanwhile, in a case where a magnetic pattern is transferred to, using the gap, a magnetic tape that has been subjected to horizontal DC erasing, a servo signal obtained by reading the formed servo pattern has a bipolar pulse shape.

In one aspect, the dimension in the width direction of the magnetic tape can be controlled by acquiring dimension information in the width direction of the magnetic tape during running by using the servo signal and adjusting and changing the tension applied in the longitudinal direction of the magnetic tape according to the acquired dimension information. Such tension adjustment can contribute to suppressing a phenomenon that, during recording or reproduction, the magnetic head for recording or reproducing data deviates from a target track position due to width deformation of the magnetic tape and data is recorded or reproduced.

Magnetic Tape Cartridge

In one aspect, the magnetic recording medium may be a magnetic tape. Another aspect of the present invention relates to a magnetic tape cartridge comprising the magnetic tape.

Details of the magnetic tape included in the magnetic tape cartridge are as described above.

In the magnetic tape cartridge, generally, the magnetic tape is accommodated inside a cartridge body in a state of being wound around a reel. The reel is rotatably provided inside the cartridge body. As the magnetic tape cartridge, a single reel type magnetic tape cartridge having one reel inside the cartridge body and a dual reel type magnetic tape cartridge having two reels inside the cartridge body are widely used. In a case where the single reel type magnetic tape cartridge is mounted on a magnetic tape device for recording and/or reproducing data on the magnetic tape, the magnetic tape is pulled out of the magnetic tape cartridge to be wound around the reel on the magnetic tape device side. A magnetic head is disposed on a magnetic tape transportation path from the magnetic tape cartridge to a winding reel. Feeding and winding of the magnetic tape are performed between a reel (supply reel) on the magnetic tape cartridge side and a reel (winding reel) on the magnetic tape device side. During this time, data is recorded and/or reproduced as the magnetic head and the magnetic layer surface of the magnetic tape come into contact with each other to be slid on each other. With respect to this, in the dual reel type magnetic tape cartridge, both reels of the supply reel and the winding reel are provided in the magnetic tape cartridge.

Magnetic Recording and Reproducing Device

Still another aspect of the present invention relates to a magnetic recording and reproducing device including the magnetic recording medium.

In the present invention and the present specification, the term “magnetic recording and reproducing device” means a device capable of performing at least one of the recording of data on the magnetic recording medium or the reproducing of data recorded on the magnetic recording medium. Such a device is generally called a drive. In one aspect, in the magnetic recording and reproducing device, recording of data on the magnetic recording medium and/or reproducing of data recorded on the magnetic recording medium can be performed as the magnetic layer surface of the magnetic recording medium and the magnetic head come into contact with each other to be slid on each other. The magnetic recording and reproducing device according to such an aspect is generally called a sliding type drive or a contact sliding type drive. The magnetic head included in the magnetic recording and reproducing device can be a recording head capable of performing the recording of data on the magnetic recording medium, or can be a reproducing head capable of performing the reproducing of data recorded on the magnetic recording medium. In addition, in one aspect, the magnetic recording and reproducing device can include both a recording head and a reproducing head as separate magnetic heads. In another aspect, the magnetic head included in the magnetic recording and reproducing device may have a configuration in which both a recording element and a reproducing element are provided in one magnetic head. As the reproducing head, a magnetic head (MR head) including a magnetoresistive (MR) element capable of sensitively reading information recorded on the magnetic recording medium as a reproducing element is preferable. As the MR head, various well-known MR heads (for example, a giant magnetoresistive (GMR) head and a tunnel magnetoresistive (TMR) head) can be used. In addition, the magnetic head which performs the recording of data and/or the reproducing of data may include a servo signal reading element. Alternatively, as a head other than the magnetic head which performs the recording of data and/or the reproducing of data, a magnetic head (servo head) comprising a servo signal reading element may be included in the magnetic recording and reproducing device. For example, a magnetic head that records data and/or reproduces recorded data (hereinafter also referred to as “recording and reproducing head”) can include two servo signal reading elements, and the two servo signal reading elements can simultaneously read two adjacent servo bands with the data band interposed therebetween. One or a plurality of elements for data can be disposed between the two servo signal reading elements. An element for recording data (recording element) and an element for reproducing data (reproducing element) are collectively referred to as an “element for data”.

In a case of recording data and/or reproducing recorded data, first, tracking using the servo signal can be performed. That is, by causing the servo signal reading element to follow a predetermined servo track, the element for data can be controlled to pass on the target data track. Displacement of the data track is performed by changing a servo track read by the servo signal reading element in a tape width direction.

The recording and reproducing head can also perform recording and/or reproduction with respect to other data bands. In this case, the servo signal reading element need only be displaced to a predetermined servo band using the above described UDIM information to start tracking for the servo band.

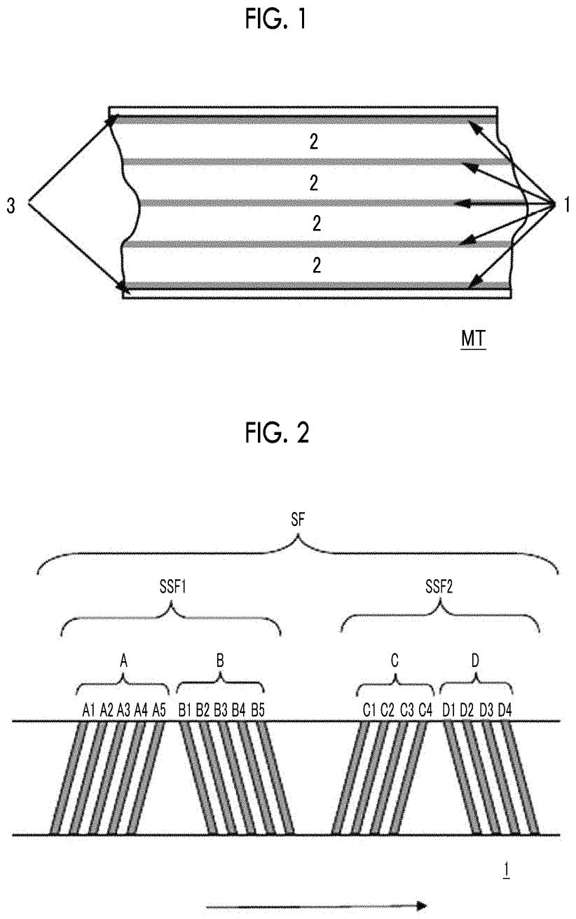

FIG. 1 shows an arrangement example of the data band and the servo band. In FIG. 1, in the magnetic layer of a magnetic tape MT, a plurality of servo bands 1 are arranged so as to be interposed between guide bands 3. A plurality of regions 2 interposed between two servo bands are data bands. The servo pattern is a magnetization region, and is formed by magnetizing a specific region of the magnetic layer by the servo write head. A region magnetized by the servo write head (a position where the servo pattern is formed) is determined by the standard. For example, in an LTO Ultrium format tape which is based on a local standard, a plurality of servo patterns inclined with respect to a tape width direction as shown in FIG. 2 are formed on a servo band, in a case of manufacturing a magnetic tape. Specifically, in FIG. 2, a servo frame SF on the servo band 1 is composed of a servo sub-frame 1 (SSF1) and a servo sub-frame 2 (SSF2). The servo sub-frame 1 is composed of an A burst (in FIG. 2, reference numeral A) and a B burst (in FIG. 2, reference numeral B). The A burst is composed of servo patterns A1 to A5 and the B burst is composed of servo patterns B1 to B5. Meanwhile, the servo sub-frame 2 is composed of a C burst (in FIG. 2, reference numeral C) and a D burst (in FIG. 2, reference numeral D). The C burst is composed of servo patterns C1 to C4 and the D burst is composed of servo patterns D1 to D4. Such 18 servo patterns are arranged in the sub-frames in an array of 5, 5, 4, 4, as the sets of 5 servo patterns and 4 servo patterns, and are used for identifying the servo frames. FIG. 2 shows one servo frame for description. Note that, in practice, a plurality of the servo frames are arranged in the running direction in each servo band in the magnetic layer of the magnetic tape on which the head tracking of the timing-based servo system is performed. In FIG. 2, an arrow shows a running direction. For example, an LTO Ultrium format tape usually has 5000 or more servo frames per 1 m of tape length in each servo band of the magnetic layer.

In the magnetic recording and reproducing device, in one aspect, the magnetic recording medium is treated as a removable medium (so-called replaceable medium), and, for example, a magnetic tape cartridge accommodating the magnetic tape therein is inserted into the magnetic recording and reproducing device and taken out. In another aspect, the magnetic recording medium is not treated as a replaceable medium, for example, the magnetic tape is wound around the reel of the magnetic recording and reproducing device comprising a magnetic head, and the magnetic tape is accommodated in the magnetic recording and reproducing device. In one aspect, in such a magnetic recording and reproducing device, the magnetic tape and the magnetic head can be accommodated in a sealed space in the magnetic recording and reproducing device. In the present invention and the present specification, the term “sealed space” refers to a space in which a degree of sealing evaluated by a dipping method (bombing method) using helium (He) specified in JIS Z 2331:2006 helium leakage test method is 10×10⁻⁸ Pa·m³/sec or less. The degree of sealing of the sealed space may be, for example, 5×10⁻⁹ Pa·m³/sec or more and 10×10⁻⁸ Pa·m³/sec or less, or may be less than the above range. In one aspect, the entire space in a housing can be the sealed space, and in another aspect, a part of the space in a housing can be the sealed space. The sealed space can be an internal space of the housing that covers the whole or a part of the magnetic recording and reproducing device. The material and shape of the housing are not particularly limited, and can be, for example, the same as the material and shape of the housing of a normal magnetic recording and reproducing device. As an example, metal, resin, or the like can be used as the material of the housing.

### EXAMPLES

Hereinafter, one aspect of the present invention will be described based on Examples. Note that the present invention is not limited to the embodiments shown in Examples. “Parts” and “%” in the following description mean “parts by mass” and “mass %”, unless otherwise specified. “eq” indicates equivalent and is a unit not convertible into SI unit.

The following various steps and operations were performed in an environment of a temperature of 20° C. to 25° C. and a relative humidity of 40% to 60%, unless otherwise noted.

In Table 1 below, “BaFe” indicates hexagonal barium ferrite powder having an average particle size (average plate diameter) of 21 nm.

As the ferromagnetic powder described as “metal powder” in Table 1 below, an iron-cobalt alloy ferromagnetic powder (average particle size (average long axis length) of 50 nm) similar to a metal powder used in Example 1 of JP2004-348897A described above was used.

In Table 1 below, “SrFe” indicates a hexagonal strontium ferrite powder produced by the method described below, and “ϵ-iron oxide” indicates an ϵ-iron oxide powder produced by the method described below.

The average particle volume of the various ferromagnetic powders described below is a value obtained by the method described above. The various values related to the particle size of the various powders described below are also values obtained by the method described above.

The anisotropy constant Ku is a value obtained by the method described above regarding each ferromagnetic powder by using a vibrating sample magnetometer (manufactured by Toei Industry Co., Ltd.).

A mass magnetization σs is a value measured at a magnetic field intensity of 15 kOe using a vibrating sample magnetometer (manufactured by Toei Industry Co., Ltd.).

Method for Producing Ferromagnetic Powder

Method for Producing Hexagonal Strontium Ferrite Powder

1707 g of SrCO₃, 687 g of H₃BO₃, 1120 g of Fe₂O₃, 45 g of Al(OH)₃, 24 g of BaCO₃, 13 g of CaCO₃, and 235 g of Nd₂O₃ were weighed and mixed by a mixer to obtain a raw material mixture.

The obtained raw material mixture was melted in a platinum crucible at a melting temperature of 1390° C., and a hot water outlet provided at a bottom of the platinum crucible was heated while stirring a melt, and the melt was discharged in a rod shape at about 6 g/sec. Hot water was rolled and quenched by a pair of water-cooling rollers to produce an amorphous body.

280 g of the produced amorphous body was charged into an electric furnace, was heated to 635° C. (crystallization temperature) at a temperature rising rate of 3.5° C./min, and was kept at the same temperature for 5 hours to precipitate (crystallize) hexagonal strontium ferrite particles.

Next, a crystallized product obtained above including hexagonal strontium ferrite particles was coarsely pulverized in a mortar, and 1000 g of zirconia beads having a particle diameter of 1 mm and 800 ml of an acetic acid aqueous solution of 1% concentration were added to the crystallized product in a glass bottle, to be dispersed by a paint shaker for 3 hours. Thereafter, the obtained dispersion liquid was separated from the beads, to be put in a stainless beaker. The dispersion liquid was statically left at a liquid temperature of 100° C. for 3 hours and subjected to a dissolving treatment of a glass component, and then the crystallized product was sedimented by a centrifugal separator to be washed by repeatedly performing decantation and was dried in a heating furnace at an in-furnace temperature of 110° C. for 6 hours to obtain a hexagonal strontium ferrite powder.

Regarding the hexagonal strontium ferrite powder (“SrFe” in Table 1 below) obtained as described above, an average particle volume was 900 nm³, an anisotropy constant Ku was 2.2×10⁵ J/m³, and a mass magnetization as was 49 A·m²/kg.

12 mg of a sample powder was collected from the hexagonal strontium ferrite powder obtained as described above, the elemental analysis of a filtrated solution obtained by the partial dissolving of this sample powder under the dissolution conditions described above was performed by the ICP analyzer, and a surface layer portion content of a neodymium atom was obtained.

Separately, 12 mg of a sample powder was collected from the hexagonal strontium ferrite powder obtained as described above, the elemental analysis of a filtrated solution obtained by the total dissolving of this sample powder under the dissolution conditions described above was performed by the ICP analyzer, and a bulk content of a neodymium atom was obtained.

A content (bulk content) of a neodymium atom with respect to 100 atom % of an iron atom in the hexagonal strontium ferrite powder obtained above was 2.9 atom %. A surface layer portion content of a neodymium atom was 8.0 atom %. It was confirmed that a ratio between a surface layer portion content and a bulk content, that is, “surface layer portion content/bulk content” was 2.8, and a neodymium atom was unevenly distributed in a surface layer of a particle.

The fact that the powder obtained above shows a crystal structure of hexagonal ferrite was confirmed by performing scanning with CuKα rays under conditions of a voltage of 45 kV and an intensity of 40 mA and measuring an X-ray diffraction pattern under the following conditions (X-ray diffraction analysis). The powder obtained above showed a crystal structure of hexagonal ferrite of a magnetoplumbite type (M type). A crystal phase detected by X-ray diffraction analysis was a single phase of a magnetoplumbite type.

PANalytical X′Pert Pro diffractometer, PIXcel detector

Soller slit of incident beam and diffraction beam: 0.017 radians

Fixed angle of dispersion slit: ¼ degrees

Mask: 10 mm

Anti-scattering slit: ¼ degrees

Measurement mode: continuous

Measurement time per stage: 3 seconds

Measurement speed: 0.017 degrees per second

Measurement step: 0.05 degrees

Method for Producing ϵ-Iron Oxide Powder

8.3 g of iron(III) nitrate nonahydrate, 1.3 g of gallium(III) nitrate octahydrate, 190 mg of cobalt(II) nitrate hexahydrate, 150 mg of titanium(IV) sulfate, and 1.5 g of polyvinylpyrrolidone (PVP) were dissolved in 90 g of pure water, and while the dissolved product was stirred using a magnetic stirrer, 4.0 g of an aqueous ammonia solution having a concentration of 25% was added to the dissolved product under a condition of an atmosphere temperature of 25° C. in an air atmosphere, and the dissolved product was stirred for 2 hours while maintaining a temperature condition of the atmosphere temperature of 25° C. A citric acid solution obtained by dissolving 1 g of citric acid in 9 g of pure water was added to the obtained solution, and the mixture was stirred for 1 hour. The powder sedimented after stirring was collected by centrifugal separation, was washed with pure water, and was dried in a heating furnace at an in-furnace temperature of 80° C.

800 g of pure water was added to the dried powder, and the powder was dispersed again in water to obtain dispersion liquid. The obtained dispersion liquid was heated to a liquid temperature of 50° C., and 40 g of an aqueous ammonia solution having a concentration of 25% was dropwise added with stirring. After stirring for 1 hour while maintaining the temperature at 50° C., 14 mL of tetraethoxysilane (TEOS) was dropwise added and was stirred for 24 hours. A powder sedimented by adding 50 g of ammonium sulfate to the obtained reaction solution was collected by centrifugal separation, was washed with pure water, and was dried in a heating furnace at an in-furnace temperature of 80° C. for 24 hours to obtain a ferromagnetic powder precursor.

The obtained ferromagnetic powder precursor was loaded into a heating furnace at an in-furnace temperature of 1000° C. in an air atmosphere and was heat-treated for 4 hours.

The heat-treated ferromagnetic powder precursor was put into an aqueous solution of 4 mol/L sodium hydroxide (NaOH), and the liquid temperature was maintained at 70° C. and was stirred for 24 hours, whereby a silicic acid compound as an impurity was removed from the heat-treated ferromagnetic powder precursor.

Thereafter, the ferromagnetic powder from which the silicic acid compound was removed was collected by centrifugal separation, and was washed with pure water to obtain a ferromagnetic powder.

The composition of the obtained ferromagnetic powder that was confirmed by high-frequency inductively coupled plasma-optical emission spectrometry (ICP-OES) has Ga, Co, and a Ti substitution type c-iron oxide (ϵ-Ga_{0.28}Co_{0.05}Ti_{0.05}Fe_{1.62}O₃). In addition, X-ray diffraction analysis was performed under the same condition as that described above for the production method of hexagonal strontium ferrite powder, and from a peak of an X-ray diffraction pattern, it was confirmed that the obtained ferromagnetic powder does not include α-phase and γ-phase crystal structures, and has a single-phase and ϵ-phase crystal structure (ϵ-iron oxide crystal structure).

Regarding the obtained ϵ-iron oxide powder (“ϵ-iron oxide” in Table 1 below), an average particle volume was 750 nm³, an anisotropy constant Ku was 1.2×10⁵ J/m³, and a mass magnetization σs was 16 A·m²/kg.

In Table 1 below, in Examples and Comparative Examples in which only one non-magnetic layer was formed, matters relating to the non-magnetic layer are shown in the column of “Lower non-magnetic layer”.

### Example 1

(1) Preparation of Alumina Dispersion

3.0 parts of 2,3-dihydroxynaphthalene (manufactured by Tokyo Chemical Industry Co., Ltd.), 31.3 parts of a 32% solution (solvent is a mixed solvent of methyl ethyl ketone and toluene) of a polyester polyurethane resin having a SO₃Na group as a polar group (UR-4800 manufactured by Toyobo Co., Ltd. (amount of a polar group: 80 meq/kg)), and 570.0 parts of a mixed solution of methyl ethyl ketone and cyclohexanone at 1:1 (mass ratio) as a solvent were mixed with respect to 100.0 parts of an α-alumina powder having an average particle size shown in Table 1, and dispersed in the presence of zirconia beads by a paint shaker for 5 hours. After the dispersion, the dispersion liquid and the beads were separated by a mesh and an alumina dispersion was obtained.

(2) Formulation of Magnetic Layer Forming Composition

| Magnetic Liquid | | |
|---|---|---|
| Ferromagnetic powder (Type: see Table 1) | 100.0 | parts |
| Polyurethane resin | 10.0 | parts |

UR-4800 manufactured by Toyobo Co., Ltd. (sulfonic acid
group-containing polyester polyurethane resin)

| | | |
|---|---|---|
| Cyclohexanone | 150.0 | parts |
| Methyl ethyl ketone | 150.0 | parts |
| Abrasive Solution | | |
| Alumina dispersion prepared in the above (1) | 6.0 | parts |
| Filler Liquid | | |
| Filler | 0.5 | parts |

Type: carbon black (average particle size: 80 nm)

| | | |
|---|---|---|
| Methyl ethyl ketone | 1.4 | parts |
| Other Components | | |
| Stearic acid | 2.0 | parts |
| Stearic acid amide | 0.2 | parts |
| Butyl stearate | 2.0 | parts |
| Polyisocyanate (CORONATE (registered trademark) | 2.5 | parts |
| L manufactured by Tosoh Corporation) | | |
| Finishing Additive Solvent | | |
| Cyclohexanone | 200.0 | parts |
| Methyl ethyl ketone | 200.0 | parts |

(3) Formulation of Non-Magnetic Layer Forming Composition

| | | |
|---|---|---|
| Non-magnetic powder: α-iron oxide | 100.0 | parts |

Average particle size (average long axis length): see Table 1
Acicular ratio: 7
Brunauer-Emmett-Teller (BET) specific surface area: 52 m²/g

| | | |
|---|---|---|
| Carbon black | 20.0 | parts |

Average particle size: 20 nm

| | | |
|---|---|---|
| SO₃Na group-containing polyurethane resin | 18.0 | parts |

Weight-average molecular weight: 70,000, SO₃Na group: 0.2 meq/g

| | | |
|---|---|---|
| Stearic acid | 2.0 | parts |
| Stearic acid amide | 0.2 | parts |
| Butyl stearate | 2.0 | parts |
| Cyclohexanone | 300.0 | parts |
| Methyl ethyl ketone | 300.0 | parts |

(4) Formulation of Back Coating Layer Forming Composition

| | | |
|---|---|---|
| Carbon black | 100.0 | parts |

Dibutyl phthalate (DBP) oil absorption amount: 74 cm³/100 g

| | | |
|---|---|---|
| Nitrocellulose | 27.0 | parts |
| Polyester polyurethane resin containing | 62.0 | parts |
| sulfonic acid group and/or salt thereof | | |
| Polyester resin | 4.0 | parts |
| Alumina powder (BET specific surface area: 17 m²/g) | 0.6 | parts |
| Methyl ethyl ketone | 600.0 | parts |
| Toluene | 600.0 | parts |
| Polyisocyanate (CORONATE (registered trademark) | 15.0 | parts |
| L manufactured by Tosoh Corporation) | | |

(5) Preparation of Each Layer Forming Composition

A magnetic layer forming composition was prepared by the following method.

A magnetic liquid was prepared by dispersing the above components for 24 hours (beads-dispersion) using a batch type vertical sand mill. As dispersion beads, zirconia beads having a bead diameter of 0.5 mm were used.

For the filler liquid, the components of the filler liquid were liquefied with a batch type ultrasonic dispersion apparatus equipped with a stirrer at a stirring rotation speed of 1500 rpm (revolutions per minute) for 30 minutes. The liquefied filler liquid was dispersed with the number of passes indicated in the column of “Filler liquid dispersion treatment” in Table 1 using a horizontal beads mill dispersing device using zirconia beads having a bead diameter of 0.5 mm, by setting a bead filling rate to 80 volume % and a circumferential speed of a rotor tip to 10 m/s, and a retention time per pass to 2 minutes. The liquid after the dispersion treatment was stirred with a dissolver stirrer at a circumferential speed of 10 m/sec for 30 minutes, and then treated with a flow type ultrasonic dispersing device at a flow rate of 3 kg/min for 3 passes.

Using the sand mill, the prepared magnetic liquid and filler liquid were mixed with the abrasive solution, and other components (other components, and finishing additive solvent) and the mixture was beads-dispersed for 5 minutes, and then the treatment (ultrasonic dispersion) was performed on the mixture for 0.5 minutes by a batch type ultrasonic apparatus (20 kHz, 300 W). Thereafter, filtration was performed using a filter having a pore diameter of 0.5 μm to prepare a magnetic layer forming composition.

A non-magnetic layer forming composition was prepared by the following method. The components described above excluding the lubricant (stearic acid, stearic acid amide, and butyl stearate) were kneaded and diluted by an open kneader, and subjected to a dispersion treatment by a horizontal beads mill dispersing device. After that, the lubricant (stearic acid, stearic acid amide, and butyl stearate) was added into the obtained dispersion liquid and stirred and mixed by a dissolver stirrer to prepare a non-magnetic layer forming composition.

Aback coating layer forming composition was prepared by the following method. The above components excluding polyisocyanate were introduced into a dissolver stirrer, stirred at a circumferential speed of 10 m/sec for 30 minutes, and then subjected to a dispersion treatment by a horizontal beads mill dispersing device. After that, polyisocyanate was added, and stirred and mixed by a dissolver stirrer, and a back coating layer forming composition was prepared.

(6) Production of Magnetic Tape and Magnetic Tape Cartridge

The non-magnetic layer forming composition prepared in the above (5) was applied onto a surface of a biaxially stretched support made of polyethylene terephthalate having a thickness of 4.1 μm so that the thickness after drying was as described in Table 1 and was dried to form a non-magnetic layer. Next, the magnetic layer forming composition prepared in the above (5) was applied onto the non-magnetic layer so that the thickness after drying was 0.1 μm to form a coating layer. After that, while the coating layer of the magnetic layer forming composition is in a wet state, a vertical alignment treatment was performed by applying a magnetic field having a magnetic field intensity of 0.3 T in a direction perpendicular to a surface of the coating layer, and then the surface of the coating layer was dried. Thereby, a magnetic layer was formed. That is, sequential coating was adopted as the coating method. After that, the back coating layer forming composition prepared in the above (5) was applied onto a surface of the support opposite to the surface on which the non-magnetic layer and the magnetic layer are formed and was dried so that the thickness after drying was 0.3 μm, and thus, a back coating layer was formed.

After that, a surface smoothing treatment (calendering treatment) was performed using a calender roll formed of only metal rolls at a speed of 100 m/min, a linear pressure of 300 kg/cm, and a calender temperature of 90° C. (surface temperature of calender roll) (number of times of calendering: 2 times).

After that, a long magnetic tape original roll was stored in a heat treatment furnace having an atmosphere temperature of 70° C. to perform a heat treatment (heat treatment time: 36 hours). After the heat treatment, the resultant was slit to have ½ inches width to obtain a magnetic tape. A servo signal was recorded on the magnetic layer of the obtained magnetic tape by a commercially available servo writer to obtain a magnetic tape having a data band, a servo band, and a guide band in an arrangement according to a linear tape-open (LTO) Ultrium format and having a servo pattern (timing-based servo pattern) in an arrangement and a shape according to the LTO Ultrium format on the servo band. The servo pattern thus formed is a servo pattern according to the description in Japanese industrial standards (JIS) X6175:2006 and Standard ECMA-319 (June 2001). The total number of servo bands is 5, and the total number of data bands is 4.

The magnetic tape (length of 970 m) after forming the servo pattern was wound around the winding core for heat treatment, and the heat treatment is performed while being wound around the winding core. As the winding core for heat treatment, a solid core member (outer diameter: 50 mm) formed of a resin and having the bending elastic modulus of 0.8 GPa was used, and the tension during winding was set as 0.6 N. The heat treatment was performed at a heat treatment temperature of 50° C. for 5 hours. The weight-basis absolute humidity in the atmosphere in which the heat treatment was performed was 10 g/kg Dry air.

After the heat treatment, the magnetic tape and the winding core for heat treatment were sufficiently cooled, the magnetic tape was removed from the winding core for heat treatment and wound around the temporary winding core, and then, the magnetic tape having the final product length (960 m) was wound around the reel (reel outer diameter: 44 mm) of the magnetic tape cartridge from the temporary winding core. The remaining length of 10 m was cut out and the leader tape based on section 9 of Standard European Computer Manufacturers Association (ECMA)-319 (June 2001) Section 3 was bonded to the terminal of the cut side by using a commercially available splicing tape. As the temporary winding core, a solid core member made of the same material and having the same outer diameter as the winding core for heat treatment was used, and the tension during winding was set as 0.6 N.

Therefore, the magnetic tape cartridge of the single reel type in which the magnetic tape having a length of 960 m was wound on the reel was produced.

### Example 2

A magnetic tape and a magnetic tape cartridge were produced by the method described in Example 1, except that an a-alumina powder having an average particle size described in Table 1 was used as the abrasive and the number of passes of dispersion treatment of the filler liquid was changed as shown in Table 1.

### Example 3

A magnetic tape and a magnetic tape cartridge were produced by the method described in Example 1, except that the non-magnetic powder of the non-magnetic layer was changed to α-iron oxide having an average particle size shown in Table 1.

### Example 4

A magnetic tape and a magnetic tape cartridge were produced by the method described in Example 3, except that a non-magnetic layer was formed by applying and drying the non-magnetic layer forming composition so that the thickness after drying was the thickness described in Table 1.

### Example 5

A magnetic tape and a magnetic tape cartridge were produced by the method described in Example 4, except that the ferromagnetic powder described in the “Ferromagnetic powder” column of Table 1 was used as the ferromagnetic powder.

### Example 6

A magnetic tape and a magnetic tape cartridge were produced by the method described in Example 1, except that two non-magnetic layers were formed as below and the magnetic layer forming composition was applied onto the formed upper non-magnetic layer to form a magnetic layer, as described in Example 1, and that the number of times of calendering was set to one.

Formulation of Lower Non-Magnetic Layer Forming Composition

| | | |
|---|---|---|
| Carbon black (average particle size: 20 nm) | 100.0 | parts |
| Trioctylamine | 4.0 | parts |
| Vinyl chloride resin | 12.0 | parts |
| Stearic acid | 1.5 | parts |
| Stearic acid amide | 0.3 | parts |
| Butyl stearate | 1.5 | parts |
| Cyclohexanone | 200.0 | parts |
| Methyl ethyl ketone | 510.0 | parts |

Formulation of Upper Non-Magnetic Layer Forming Composition

| | | |
|---|---|---|
| Non-magnetic powder α-iron oxide | 100.0 | parts |

Average particle size (average long axis length): 30 nm
Average short axis length: 15 nm
Acicular ratio: 2.0

| | | |
|---|---|---|
| SO₃Na group-containing polyurethane resin | 18.0 | parts |

Weight-average molecular weight: 70,000, SO₃Na group: 0.2 meq/g

| | | |
|---|---|---|
| Stearic acid | 1.0 | part |
| Cyclohexanone | 300.0 | parts |
| Methyl ethyl ketone | 300.0 | parts |

For each of the lower non-magnetic layer forming composition and the upper non-magnetic layer forming composition, the components were kneaded by an open kneader for 240 minutes and then dispersed by a sand mill. As the dispersion conditions of each non-magnetic layer forming composition, a dispersion time was 24 hours, and zirconia beads having a bead diameter of 0.1 mm were used as dispersion beads. 4.0 parts of polyisocyanate (CORONATE 3041 manufactured by Tosoh Corporation) were added to each dispersion liquid obtained, and the mixture was further stirred and mixed for 20 minutes, and then filtered using a filter having a pore diameter of 0.5 μm.

Based on the above, the lower non-magnetic layer forming composition and the upper non-magnetic layer forming composition were prepared.

The lower non-magnetic layer forming composition was applied onto a surface of the same support as in Example 1 so that the thickness after the drying is the thickness described in Table 1, and was dried in the environment of an atmosphere temperature of 100° C., to form a lower non-magnetic layer. The upper non-magnetic layer forming composition was applied onto the lower non-magnetic layer so that the thickness after drying is the thickness described in Table 1, and was dried in an environment of an atmosphere temperature of 100° C., to form an upper non-magnetic layer.

### Examples 7 and 8

A magnetic tape and a magnetic tape cartridge were produced by the method described in Example 6, except that the ferromagnetic powder described in the “Ferromagnetic powder” column of Table 1 was used as the ferromagnetic powder.

### Comparative Example 1

A magnetic tape and a magnetic tape cartridge were produced by the method described in Example 1, except that an a-alumina powder having an average particle size shown in Table 1 was used as the abrasive.

### Example 9

A magnetic tape was produced by the method described for Comparative Example 1. Before accommodating the produced magnetic tape in the magnetic tape cartridge, the entire length of the magnetic tape was subjected to the following sliding treatment (hereinafter, referred to as “sliding treatment during manufacturing step”).

A recording and reproducing head (LTO 8 head) mounted on a linear tape-open (LTO) 8 tape drive manufactured by IBM Corporation was used as the sliding member. In a magnetic tape transport device, the magnetic tape was run under the following running conditions so that the sliding member and the surface of the magnetic layer were brought into contact with each other to be slid on each other. A value of a tension applied in the longitudinal direction of the magnetic tape and a running speed of the magnetic tape are set values in the magnetic tape transport device. Regarding a unit, “gf” indicates a gram-force, and 1 N (Newton) is about 102 gf.

Running Conditions

Running speed of magnetic tape: 4 m/sec

Tension applied in longitudinal direction of magnetic tape: 100 gf

Running pass of magnetic tape: 20,000 single-pass

Wrap angle θ: 1°

### Comparative Example 2

A magnetic tape and a magnetic tape cartridge were manufactured by the method described in Comparative Example 1, except that the number of passes of the dispersion treatment of the filler liquid was changed as shown in Table 1.

### Comparative Example 3

A magnetic tape was produced according to the description of Example 1 of JP2014-209403A. Note that, as the ferromagnetic powder, the ferromagnetic powder shown in Table 1 was used as in Example 1 and the like, as the abrasive, the a-alumina powder having an average particle size shown in Table 1 was used as in Comparative Example 1 and the like, and, as the non-magnetic powder of the non-magnetic layer, the carbon black and the α-iron oxide having an average particle size shown in Table 1 were used as in Example 1 and the like. As disclosed in a paragraph 0067 of JP2014-209403A, the filler contained in the magnetic layer is colloidal silica. For Comparative Example 3, since the magnetic layer forming composition was prepared according to the description in a paragraph 0071 of JP2014-209403A, the liquid containing colloidal silica was not subjected to a dispersion treatment (dispersion treatment of the filler liquid) before mixing with other components.

The produced magnetic tape was accommodated in the magnetic tape cartridge after forming a servo pattern by the same method as in Example 1.

Therefore, the single reel type magnetic tape cartridge in which the magnetic tape having a length of 960 m is wound on the reel was produced.

### Comparative Example 4

Using the metal powder described above, a magnetic tape was produced according to the description of Example 1 of JP2004-348897A. As disclosed in a paragraph 0050 of JP2004-348897A, the coating method of the magnetic layer and the non-magnetic layer is simultaneous multilayer coating. For Comparative Example 4, since the magnetic layer forming composition was prepared according to the description in a paragraph 0050 of JP2004-348897A, the liquid containing carbon black was not subjected to a dispersion treatment (dispersion treatment of the filler liquid) before mixing with other components.

The produced magnetic tape was accommodated in the magnetic tape cartridge after forming a servo pattern by the same method as in Example 1.

Therefore, the single reel type magnetic tape cartridge in which the magnetic tape having a length of 960 m is wound on the reel was produced.

For Examples and Comparative Examples, two magnetic tape cartridges were produced, one used for obtaining the following protrusion height difference Δ and magnetic layer surface Ra and the other used for evaluating electromagnetic conversion characteristics before and after repeated running under a high temperature environment, which will be described below.

Physical Property Evaluation

(1) Magnetic Layer Surface Ra

The following conditions were adopted as the measurement conditions of the AFM, and the magnetic layer surface Ra was obtained for each of the magnetic tapes of Examples and Comparative Examples by the method described above.

The region of the area of 40 μm×40 μm on the surface of the magnetic layer of the magnetic tape is measured with an AFM (Nanoscope 4 manufactured by Veeco Instruments, Inc.) in a tapping mode. RTESP-300 manufactured by BRUKER is used as a probe, a resolution is set to 512 pixel×512 pixels, and a scan speed is set to a speed at which one screen (512 pixels×512 pixels) is measured in 341 seconds.

(2) Protrusion Height Difference Δ

For each of the magnetic tapes of Examples and Comparative Examples, the protrusion height HD and the protrusion height HB were obtained by the method described above. The protrusion height difference Δ (HD−HB) was calculated from the obtained value.

For Examples and Comparative Examples shown in Table 2 below, a reference protrusion height difference Δ_{ref} was obtained from the measurement results acquired by the method described above for three measurement regions on the surface of the magnetic layer as follows.

For each measurement region, an arithmetic average of the heights of the dark regions with the reference plane of 0 nm was obtained as an arithmetic average of all the dark regions. In this way, an arithmetic average of the three values obtained for the three measurement regions was calculated and used as HD_{ref}. In addition, for each measurement region, an arithmetic average of the heights of the bright regions with the reference plane of 0 nm was obtained as an arithmetic average of all the bright regions. In this way, an arithmetic average of the three values obtained for the three measurement regions was calculated and used as HB_{ref}.

The reference protrusion height difference Δ_{ref}=HD_{ref}−HB_{ref} was calculated from the above HD_{ref} and HB_{ref}. The reference protrusion height difference Δ_{ref} can be said to be a protrusion height difference between the dark region and the bright region obtained using the reference plane of 0 nm. Here, “ref” is used as an abbreviation for “reference”.

Evaluation of Electromagnetic Conversion Characteristic before and after Repeated Running under High Temperature Environment

(1) Evaluation of Electromagnetic Conversion Characteristic before Repeated Running under High Temperature Environment

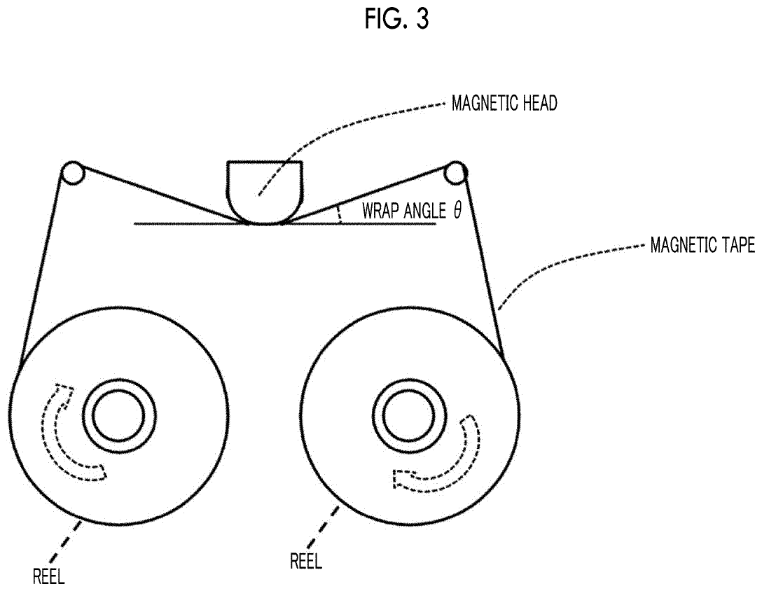

The following evaluation of the electromagnetic conversion characteristics was performed in an environment of an atmosphere temperature of 23° C.±1° C. and a relative humidity of 50%. FIG. 3 is a schematic view of a reel tester used for running the magnetic tape.

For each of Examples and Comparative Examples, the tape sample having a length of 100 m cut out from any position in the longitudinal direction of the magnetic tape taken out from the magnetic tape cartridge was attached to a reel tester having ½ inches to which the recording and reproducing head (LTO 8 head) mounted on a linear tape-open (LTO) 8 tape drive manufactured by IBM Corporation was fixed, as shown in FIG. 3. Specifically, one end part of the tape sample was fixed to one tape reel of the reel tester, the other end part was fixed to the other tape reel of the reel tester, whereby the tape sample was attached to the reel tester. The “LTO 8 head” is a magnetic head according to an LTO 8 standard. The tape sample was run on the reel tester, and the surface of the magnetic layer and the magnetic head come into contact with each other to be slid on each other, to record and reproduce data. Running conditions of the magnetic tape (the above-described tape sample) were as follows. The following value of a tension applied in the longitudinal direction of the magnetic tape and the following running speed of the magnetic tape are set values in the reel tester. As described above, regarding a unit, “gf” indicates a gram-force, and 1 N (Newton) is about 102 gf.

Running Conditions

Running speed of magnetic tape: 4 m/sec

Tension applied in longitudinal direction of magnetic tape: 100 gf

Running pass of magnetic tape: 1 single-pass

Wrap angle θ: 1°

The recording was performed at a linear recording density of 300 kfci, the reproduction output during reproduction was measured, and a signal-to-noise ratio (SNR) was obtained as a signal-to-noise ratio (ratio of the reproduction output to noise). The unit kfci is a unit of linear recording density (cannot be converted to SI unit system).

(2) Repeated Running under High Temperature Environment

The tape sample after the evaluation of the above (1) was run under the running conditions described in the above (1) while being attached to the reel tester as described in the above (1) under an environment of an atmosphere temperature of 65° C. and a relative humidity of 10%, and the surface of the magnetic layer and the magnetic head were brought into contact with each other to be slid on each other.

(3) Evaluation of Electromagnetic Conversion Characteristic after Repeated Running under High Temperature Environment

For the magnetic tape after repeated running of the above (2), the electromagnetic conversion characteristics were evaluated as described in (1) above, except that the running pass of the magnetic tape was set to 20,000 single-pass in an environment of an atmosphere temperature of 23° C.±1° C. and a relative humidity of 50%.

(4) SNR Decrease Amount (ΔSNR) before and after Repeated Running under High Temperature Environment

The SNR at the time of recording and reproducing in the above (1) was defined as “SNR before repeated running”, and the SNR at the time of recording and reproducing at the 20,000th single-pass in the above (3) was defined as “SNR after repeated running”, to calculate ΔSNR by the following Equation. In a case where the amount of change in the SNR after the repeated running with respect to the SNR before the repeated running is within 3.0 dB, it can be said that the deterioration in electromagnetic conversion characteristics after the repeated running under a high temperature environment is small.

ΔSNR=(SNR after repeated running)−(SNR before repeated running)

In Comparative Example 4, since a large number of scratches were generated on the magnetic layer during repeated running under a high temperature environment of the above (2), the electromagnetic conversion characteristics of the above (3) could not be evaluated (in Table 1, indicated as “Not evaluable” in the column of ΔSNR).

TABLE 1

| | Magnetic layer | | | | | | Upper non- |
|---|---|---|---|---|---|---|---|
| | | Abrasive | | Filler | Lower non- | | magnetic layer |
| | Ferro- | average | | liquid | magnetic layer | | Non- |
| | magnetic | particle | | dispersion | Non-magnetic | Thick- | magnetic |
| | powder | size | Filler | treatment | powder | ness | powder |
| Example 1 | BaFe | 0.09 μm | Carbon | 6 passes | Carbon black/150 | 0.7 μm | — |
| | | | black | | nm α-iron oxide | | |
| Example 2 | BaFe | 0.10 μm | Carbon | 3 passes | Carbon black/150 | 0.7 μm | — |
| | | | black | | nm α-iron oxide | | |
| Example 3 | BaFe | 0.09 μm | Carbon | 6 passes | Carbon black/70 | 0.7 μm | — |
| | | | black | | nm α-iron oxide | | |
| Example 4 | BaFe | 0.09 μm | Carbon | 6 passes | Carbon black/70 | 0.4 μm | — |
| | | | black | | nm α-iron oxide | | |
| Example 5 | SrFe | 0.09 μm | Carbon | 6 passes | Carbon black/70 | 0.4 μm | — |
| | | | black | | nm α-iron oxide | | |
| Example 6 | BaFe | 0.09 μm | Carbon | 6 passes | Carbon black | 0.25 μm | α-Iron |
| | | | black | | | | oxide |
| Example 7 | SrFe | 0.09 μm | Carbon | 6 passes | Carbon black | 0.25 μm | α-Iron |
| | | | black | | | | oxide |
| Example 8 | α-Iron | 0.09 μm | Carbon | 6 passes | Carbon black | 0.25 μm | α-Iron |
| | oxide | | black | | | | oxide |
| Example 9 | BaFe | 0.10 μm | Carbon | 6 passes | Carbon black/150 | 0.7 μm | — |
| | | | black | | nm α-iron oxide | | |
| Comparative | BaFe | 0.10 μm | Carbon | 6 passes | Carbon black/150 | 0.7 μm | — |
| Example 1 | | | black | | nm α-iron oxide | | |
| Comparative | BaFe | 0.10 μm | Carbon | 12 passes | Carbon black/150 | 0.7 μm | — |
| Example 2 | | | black | | nm α-iron oxide | | |
| Comparative | BaFe | 0.10 μm | Colloidal | Not | Carbon black/150 | 0.1 μm | — |
| Example 3 | | | silica | performed | nm α-iron oxide | | |
| Comparative | Metal | 0.10 μm | Carbon | Not | Carbon black/150 | 1.0 μm | — |
| Example 4 | powder | | black | performed | nm α-iron oxide | | |
| | | | | Sliding | | | |
| | | Upper non- | | treatment | Magnetic | Protrusion | |
| | | magnetic layer | | during | layer | height | |
| | | Thick- | Coating | manufacturing | surface | difference | |
| | | ness | method | step | Ra | Δ | ΔSNR |
| | Example 1 | — | Successive | Not | 2.0 nm | 1.3 nm | −0.2 dB |
| | | | multilayer | performed | | | |
| | Example 2 | — | Successive | Not | 2.3 nm | 3.0 nm | 0 dB |
| | | | multilayer | performed | | | |
| | Example 3 | — | Successive | Not | 1.5 nm | 1.5 nm | −0.3 dB |
| | | | multilayer | performed | | | |
| | Example 4 | — | Successive | Not | 2.0 nm | 1.2 nm | −0.5 dB |
| | | | multilayer | performed | | | |
| | Example 5 | — | Successive | Not | 2.1 nm | 1.2 nm | −0.7 dB |
| | | | multilayer | performed | | | |
| | Example 6 | 0.25 | Successive | Not | 1.2 nm | 0.9 nm | −1.5 dB |
| | | μm | multilayer | performed | | | |
| | Example 7 | 0.25 | Successive | Not | 1.3 nm | 0.8 nm | −1.8 dB |
| | | μm | multilayer | performed | | | |
| | Example 8 | 0.25 | Successive | Not | 1.4 nm | 0.9 nm | −2.5 dB |
| | | μm | multilayer | performed | | | |
| | Example 9 | — | Successive | Performed | 1.8 nm | 1.0 nm | −0.2 dB |
| | | | multilayer | | | | |
| | Comparative | — | Successive | Not | 2.2 nm | 0.4 nm | −3.2 dB |
| | Example 1 | | multilayer | performed | | | |
| | Comparative | — | Successive | Not | 2.0 nm | 0.4 nm | −3.5 dB |
| | Example 2 | | multilayer | performed | | | |
| | Comparative | — | Successive | Not | 1.5 nm | 0.2 nm | −5.0 dB |
| | Example 3 | | multilayer | performed | | | |
| | Comparative | — | Simultaneous | Not | 3.0 nm | 3.1 nm | Not |
| | Example 4 | | multilayer | performed | | | evaluable |

TABLE 2

| | Protrusion height | Reference protrusion |
|---|---|---|
| | difference Δ | height difference Δ_{ref} |
| Example 1 | 1.3 nm | 2.6 nm |
| Example 9 | 1.0 nm | 1.2 nm |
| Comparative Example 1 | 0.4 nm | 1.1 nm |
| Comparative Example 2 | 0.4 nm | 1.1 nm |

From the results shown in Table 1, it can be confirmed that the deterioration in electromagnetic conversion characteristics after repeated running under a high temperature environment is suppressed in the magnetic tapes of Examples as compared with the magnetic tapes of Comparative Examples.

In addition, from the results shown in Table 2, it can be confirmed that a magnitude relation of the protrusion height difference Δ obtained by using the height of the peripheral base region of 0 nm as a reference does not correspond to a magnitude relation of the reference protrusion height difference Δ_{ref} obtained by using the reference plane of 0 nm.

One aspect of the present invention is useful in the technical field of a data storage magnetic tape.

What is claimed is:

1. A magnetic recording medium comprising:
a non-magnetic support; and
a magnetic layer containing a ferromagnetic powder,
wherein an arithmetic average roughness Ra measured on a surface of the magnetic layer is 2.5 nm or less, and
a protrusion height difference Δ, HD−HB, between a protrusion height HD with a height of a peripheral base region of 0 nm as a reference, which is measured by an atomic force microscope, for a region specified as a dark region in a first binarization-processed image of a reflected electron image obtained by imaging the surface of the magnetic layer with a scanning electron microscope and a protrusion height HB with a height of a peripheral base region of 0 nm as a reference, which is measured by the atomic force microscope, for a region specified as a bright region in a second binarization-processed image of the reflected electron image obtained by imaging the surface of the magnetic layer with the scanning electron microscope, the second binarization processing being performed on a higher gradation side than the first binarization processing, is 0.7 nm or more.

2. The magnetic recording medium according to claim 1,
wherein the protrusion height difference Δ is 0.7 nm or more and 3.0 nm or less.

3. The magnetic recording medium according to claim 1,
wherein the arithmetic average roughness Ra is 0.8 nm or more and 2.5 nm or less.

4. The magnetic recording medium according to claim 2,
wherein the arithmetic average roughness Ra is 0.8 nm or more and 2.5 nm or less.

5. The magnetic recording medium according to claim 1,
wherein the magnetic layer contains two or more kinds of non-magnetic powders.

6. The magnetic recording medium according to claim 5,
wherein the non-magnetic powder of the magnetic layer includes an alumina powder.

7. The magnetic recording medium according to claim 5,
wherein the non-magnetic powder of the magnetic layer includes carbon black.

8. The magnetic recording medium according to claim 6,
wherein the non-magnetic powder of the magnetic layer includes carbon black.

9. The magnetic recording medium according to claim 2,
wherein the magnetic layer contains two or more kinds of non-magnetic powders.

10. The magnetic recording medium according to claim 9,
wherein the non-magnetic powder of the magnetic layer includes an alumina powder and carbon black.

11. The magnetic recording medium according to claim 3,
wherein the magnetic layer contains two or more kinds of non-magnetic powders.

12. The magnetic recording medium according to claim 11,
wherein the non-magnetic powder of the magnetic layer includes an alumina powder and carbon black.

13. The magnetic recording medium according to claim 4,
wherein the magnetic layer contains two or more kinds of non-magnetic powders.

14. The magnetic recording medium according to claim 13,
wherein the non-magnetic powder of the magnetic layer includes an alumina powder and carbon black.

15. The magnetic recording medium according to claim 1, further comprising:
a non-magnetic layer containing a non-magnetic powder between the magnetic layer and the non-magnetic support.

16. The magnetic recording medium according to claim 1, further comprising:
a back coating layer containing a non-magnetic powder on a surface side of the non-magnetic support opposite to a surface side on which the magnetic layer is provided.

17. The magnetic recording medium according to claim 1,
wherein the magnetic recording medium is a magnetic tape.

18. A magnetic tape cartridge comprising:
the magnetic tape according to claim 17.

19. A magnetic recording and reproducing device comprising:
the magnetic recording medium according to claim 1.
